(19) United States
(12) Patent Application Publication
(10) Pub. No.: US 2026/0309402 A1
(43) Pub. Date: Oct. 8, 2026

(54) DOOR BODY ASSEMBLY FOR BUILT-IN REFRIGERATION DEVICE, AND REFRIGERATION DEVICE

(71) Applicants: HEFEI MIDEA REFRIGERATOR CO., LTD., Hefei (CN); HEFEI HUALING CO., LTD., Hefei (CN); MIDEA GROUP CO., LTD., Foshan (CN)

(72) Inventors: Zhanwei Liu, Hefei (CN); Dalei Yin, Hefei (CN); Xianshi Yang, Hefei (CN)

(21) Appl. No.: 19/161,242

(22) PCT Filed: Nov. 19, 2024
(86) PCT No.: PCT/CN2024/132874

§ 371 Date: Aug. 30, 2025

(30) Foreign Application Priority Data
Nov. 27, 2023 (CN) 202323218961.3
Jan. 22, 2024 (CN) 202410088590.1
Aug. 26, 2024 (CN) 202422090015.3

(51) Int. Cl. F25D 23/02; E05F 17/00

(52) U.S. Cl. CPC F25D 23/021; E05F 17/002; F25D 23/028; E05Y 2201/604; E05Y 2201/654; E05Y 2201/708; E05Y 2900/31; F25D 2323/024

(57) ABSTRACT

A door body assembly for a built-in refrigeration device is disclosed. The assembly includes an enclosure door rotatably connected to a refrigeration enclosure body, which is installed within an accommodating space formed by an installation body. A door panel is mounted on the enclosure door via a sliding mechanism and is configured to move in the width direction of the enclosure door. A traction mechanism is connected to the sliding mechanism and drives the door panel to move during opening or closing of the enclosure door. The distance between the hinge axis and the opening of the accommodating space is t, and the distance between the hinge axis and the hinge-side end face of the enclosure door is l3. The door panel's movement distance is d, with a minimum of 14.15-109.108 mm. The maximum door opening angle ranges from 90° to 135° and is positively correlated with the movement distance d.

### CROSS-REFERENCES TO RELATED APPLICATIONS

The present application claims priority to Chinese patent application No. 202323218961.3 filed on Nov. 27, 2023, entitled “Refrigerator Hinge”, to Chinese patent application No. 202410088590.1 filed on Jan. 22, 2024, entitled “Door Body Assembly and Refrigeration Apparatus”, and to Chinese patent application No. 202422090015.3 filed on Aug. 26, 2024, entitled “Door Body Assembly for embedded Refrigeration Apparatus and Refrigeration Apparatus”, which are hereby incorporated by reference in their entireties.

### FIELD

The present application relates to the field of home appliances, and in particular to door body assemblies for an embedded refrigeration apparatus and a refrigeration apparatus.

### BACKGROUND

With the growing demand for the integration of home appliances and home furnishings, an embedded design of home appliances has become a trend.

However, to achieve better effect of home integration, it is sometimes necessary additionally to fixedly connect a door panel to a surface of a box door and requirements for a gap between an embedded appliance and sidewalls of a cupboard are high to further enhance the effect of home integration. This results in that, using a traditional hinge technology, the door body assembly with a door panel is likely to interfere with a sidewall of a mounting space inside the cupboard during opening and closing processes after the appliance is embedded in the cupboard to allow the door body assembly of the appliance to be opened or closed improperly.

### BRIEF SUMMARY

The present application is intended to solve at least one of problems above. The present application provides a door body assembly for an embedded refrigeration apparatus and a refrigeration apparatus to solve a problem that a door body assembly with a door panel is likely to interfere with a sidewall of a mounting space during opening and closing processes to allow the door body assembly of the appliance to be opened or closed improperly.

According to an embodiment of the present application, there is provided a door body assembly for an embedded refrigeration apparatus including:
a box door rotatably connected to a refrigeration box body, where the refrigeration box body is embedded in an accommodation space formed by a mount body, a distance between a hinge shaft center of the box door and an opening of the accommodation space is t, and a distance between the hinge shaft center and an end surface of the box door on a hinge side is l3;
a slide mechanism;
a door panel movably mounted to the box door through the slide mechanism and movable along a width direction of the box door by a movement distance of d, and
a traction mechanism connected to the slide mechanism, where during an opening and closing process of the box door, the traction mechanism drives the slide mechanism to cause the door panel to move relative to the box door;
where a maximum door opening angle of the door body assembly is 90° to 135°, a minimum value of the movement distance d of the door panel is between 14.15 mm and 109.108 mm, and the maximum door opening angle is positively correlated with the minimum value of the movement distance d.

According to an embodiment of the present application, when the maximum door opening angle is 90° to 135° and the minimum value of the movement distance d corresponding to the maximum door opening angle is between 14.15 mm and 109.108 mm, it can be ensured that the door panels do not interfere with each other, and the minimum value of the movement distance can be used as a reference standard for designing the slide mechanism to ensure that the obtained door body assembly can enhance user's experience.

In an embodiment, a thickness of the door panel is 12 mm to 25 mm, and a thickness of the box door is 20 mm to 60 mm.

In an embodiment, a safety gap between the interference position of the door panel and a panel of the mount body at the maximum door opening angle is 1 mm to 5 mm, a fit-up gap between the door panel and the box door is 1 mm to 10 mm, and a gap between the box door and the refrigeration box body is 3 mm to 15 mm.

In an embodiment, after the interference position moves away from the accommodation space, the movement distance d of the door panel and the maximum door opening angle Δθ of the door body assembly satisfy:

$$d = ( A + B + C + D 1 + D 2 - E ) / sin ( 180 - Δθ ) ;$$

where A is a safety gap between the interference position of the door panel and a panel of the mount body at the maximum door opening angle, B is a fit-up gap between the door panel and the box door, C is a gap between the box door and the refrigeration box body, D1 is a thickness of the door panel, D2 is a thickness of the box door, and E is a distance between an innermost corner of the box door and the refrigeration box body at the maximum door opening angle.

In an embodiment, the slide mechanism includes:
a first pedestal having a first side formed with a first guide rail and a second side formed with a second guide rail;
a first slider slidably provided at the first guide rail, where the traction mechanism is rotatably connected between the box body and the first slider;
a second slider slidably provided at the second guide rail for being connected to the door panel 21; and
a flexible cable having two ends connected to the first slider and the second slider, respectively;
where in a case that the first slider moves at the first guide rail, the first slider drives the second slider in an opposite direction at the second guide rail through the flexible cable to drive the door panel to move relative to a width direction of the box door.

In an embodiment, the flexible cable includes:
a first flexible cable passing through a first end of the first pedestal, where two ends of the first flexible cable are connected to a first end of the first slider and the second slider, respectively; and a second flexible cable passing through a second end of the first pedestal, where two ends of the second flexible cable are connected to a second end of the first slider and the second slider, respectively.

In an embodiment, the traction mechanism includes a traction rod, a first rotary shaft fixation base, and a second rotary shaft fixation base;
where the first rotary shaft fixation base is connected to the first slider, the second rotary shaft fixation base is connected to the box body, a first end of the traction rod is rotatably connected to the first rotary shaft fixation base, and a second end of the traction rod is rotatably connected to the second rotary shaft fixation base.

In an embodiment, the slide mechanism includes:
a guide and a slide member, where the guide is provided at the box door and is provided with a guide structure, and the slide member is provided at the door panel and is movably provided at the guide along the width direction of the box door;
a link assembly movably provided at the guide structure and is deformable under the guidance of the guide structure, where a second end of the link assembly is movably connected to the slide member; and
a drive rod provided at the box body and movably connected to a first end of the link assembly to drive the link assembly to be deformed during the opening and closing process of the box door to further drive the slide member to move the door panel along the width direction through the link assembly.

In an embodiment, the link assembly includes:
a first link and a second link, where the drive rod is rotatably connected to a first end of the first link, a second end of the first link is rotatably connected to a first end of the second link through a first hinge shaft, the first hinge shaft is provided at the guide structure and moves along a thickness direction of the door panel under the guidance of the guide structure and a second end of the second link is rotatably connected to the slide member;
where the drive rod is configured to drive the first end of the first link to move along the width direction, the first link is configured to drive the first hinge shaft to move along the thickness direction to change an angle between the first link and the second link to allow the second link to drive the slide member to move in a direction opposite to the driving direction of the drive rod.

A refrigeration apparatus according to an embodiment of the present application includes:
a box body provided with a storage space; and
the door body assembly mentioned above, where the box door is rotatably connected to the box body to open or close the storage space.

Additional aspects and advantages of the present application will be set forth in part in the description which follows and, in part, will be apparent from the description, or may be learned by practice of the present application.

### BRIEF DESCRIPTION OF THE DRAWINGS

To more clearly illustrate solutions in the embodiments of the present application or the related art, the drawings that need to be used in the descriptions of the embodiments or the related art will be briefly described below. The drawings in the following description are only certain embodiments of the present application, and for those skilled in the related art, other drawings may be obtained based on these drawings without any creative work.

FIG. 1 is a mounting schematic diagram of a door body assembly for a refrigeration apparatus according to the embodiment of the present application;

FIG. 2 is a partial enlarged schematic diagram of FIG. 1;

FIG. 3 is a schematic structural diagram in which a box door of a refrigeration apparatus is opened outwards according to the embodiment of the present application;

FIG. 4 is an exploded diagram of a refrigeration apparatus according to an embodiment of the present application;

FIG. 5 is a first schematic diagram of a slide door mechanism according to an embodiment of the present application;

FIG. 6 is a second schematic diagram of a slide door mechanism according to an embodiment of the present application;

FIG. 7 is an exploded diagram of a slide door mechanism according to an embodiment of the present application;

FIG. 8 is a schematic structural diagram of a slide door mechanism according to an embodiment of the present application;

FIG. 9 is a schematic structural diagram of a guide according to an embodiment of the present application;

FIG. 10 is a schematic structural diagram of a slide member according to an embodiment of the present application;

FIG. 11 is a first schematic structural diagram of a first driven guide rail mechanism according to an embodiment of the present application;

FIG. 12 is a second schematic structural diagram of a first driven guide rail mechanism according to an embodiment of the present application;

FIG. 13 is a first schematic structural diagram of a second driven guide rail mechanism according to an embodiment of the present application;

FIG. 14 is a second schematic structural diagram of a second driven guide rail mechanism according to an embodiment of the present application;

FIG. 15 is a schematic diagram of a door panel according to the embodiment of the present application;

FIG. 16 is a schematic diagram of a first hook and a second hook according to an embodiment of the present application;

FIG. 17 is a schematic diagram of a box door, a first end cover, and a second end cover according to an embodiment of the present application;

FIG. 18 is an assembly schematic diagram of a box door, a first end cover, a second end cover, a slide door mechanism, driven guide rail mechanisms, and hinges according to an embodiment of the present application;

FIG. 19 is a schematic diagram of a first end cover according to an embodiment of the present application;

FIG. 20 is a schematic diagram of a second end cover according to an embodiment of the present application;

FIG. 21 is a schematic diagram of a door panel when door panels need to be mounted according to the embodiment of the present application;

FIG. 22 is a schematic diagram of a door panel when no door panels need to be mounted according to the embodiment of the present application;

FIG. 23 is a first schematic diagram of a first primary decorative cover according to an embodiment of the present application;

FIG. 24 is a second schematic diagram of a first primary decorative cover according to an embodiment of the present application;

FIG. 25 is a schematic diagram of a first secondary decorative cover according to an embodiment of the present application;

FIG. 26 is a first schematic diagram of a second primary decorative cover according to an embodiment of the present application;

FIG. 27 is a second schematic diagram of a second primary decorative cover according to an embodiment of the present application;

FIG. 28 is a schematic diagram of a second secondary decorative cover according to an embodiment of the present application;

FIG. 29 is a schematic diagram of a third end cover according to an embodiment of the present application;

FIG. 30 is a schematic diagram of a fourth end cover according to an embodiment of the present application;

FIG. 31 is a first schematic diagram of a third primary decorative cover according to an embodiment of the present application;

FIG. 32 is a second schematic diagram of a third primary decorative cover according to an embodiment of the present application;

FIG. 33 is a schematic diagram of a third secondary decorative cover according to an embodiment of the present application;

FIG. 34 is a first schematic diagram of a fourth primary decorative cover according to an embodiment of the present application;

FIG. 35 is a second schematic diagram of a fourth primary decorative cover according to an embodiment of the present application; and

FIG. 36 is a schematic diagram of a fourth secondary decorative cover according to an embodiment of the present application.

### REFERENCE SIGNS

1: box body; 110: first connection hole; 120: first beam body; 121: second connection hole;
130: second beam body; 131: fourth connection hole; 132: third connection hole;
2: box door;
210: first end cover; 211: first hinge hole; 212: third mount slot; 213: first mount slot;
214: first avoidance opening; 215: second avoidance opening; 216: first mount hole; 217: first protrusion ridge; 218: third recess; 219: fourth recess;
220: second end cover; 221: first guide rail fixation base; 223: second mount hole;
224: third mount hole; 225: second protrusion ridge; 227: third protrusion ridge;
310: third end cover; 311: second guide rail fixation base; 313: eighth protrusion ridge;
314: second hinge hole; 315: fourth mount hole; 316: hand grip slot;
320: fourth end cover; 321: fourth avoidance opening; 322: third avoidance opening; 323: fifth mount slot;
324: sixth mount slot; 325: fifth mount hole; 327: ninth protrusion ridge;
4: first hinge; 5: second hinge; 6: third hinge;
7: slide door mechanism; 701: first fixation base; 702: second fixation base; 703: second adjustment member;
704: first adjustment member; 705: first bearing; 706: flexible cable; 707: first rotary shaft fixation base; 708: pin; 709: traction rod; 710: second rotary shaft fixation; 711: connector; 712: first connection block; 713: second slider; 714: first slider; 715: third bearing; 716: second bearing; 717: first pedestal;
730: guide; 731: guide structure; 732: fixation panel; 733: slide recess; 734: slide bushing;
7311: first limit slot; 7312: second limit slot;
740: slide member; 741: guide rod; 742: slide block; 743: first connection arm;
744: second connection arm; 745: slide contact;
760: drive rod; 770: elastic member;
750: link assembly; 751: first link; 752: second link; 753: first hinge shaft;
754: second hinge shaft; 755: third hinge shaft;
8: first driven guide rail mechanism; 801: third fixation base; 802: fourth fixation base;
803: fourth adjustment member; 804: third adjustment member; 812: second connection block; 813: third slider; 817: second pedestal;
9: second driven guide rail mechanism; 901: fifth fixation base; 902: third pedestal;
903: fourth slider; 904: sixth fixation base; 905: third connection block;
13: first primary decorative cover; 1301: fifth notch; 1302: fourth notch;
1303: first notch; 1304: second notch; 1305: first snap slot; 1306: second protrusion rib; 1307: first protrusion rib;
14: second primary decorative cover; 1401: third notch; 1403: fourth protrusion ridge; 1404: sixth protrusion ridge;
1405: second snap slot; 1406: third snap slot; 1407: seventh protrusion ridge; 1408: fifth protrusion ridge;
15: third primary decorative cover; 1501: sixth notch; 1503: fourth snap slot;
16: fourth primary decorative cover; 1601: seventh notch; 1602: eighth notch;
1603: tenth notch; 1604: ninth notch; 1605: sixth snap slot; 1606: fifth snap slot;
17: first secondary decorative cover; 18: second secondary primary decorative cover; 1801: handle portion;
19: third secondary decorative cover; 20: fourth secondary decorative cover;
21: door panel; 2111: first hook; 2112: second hook; and
60: cupboard.

### DETAILED DESCRIPTION

Embodiments of the present application are further described in detail below with reference to the drawings and embodiments. The following embodiments are intended to illustrate the application, but are not intended to limit the scope of the application.

In the description of the embodiments of the present application, it should be noted that the orientation or positional relationships indicated by the terms such as “center”, “longitudinal”, “lateral”, “upper”, “lower”, “front”, “back”, “left”, “right”, “vertical”, “horizontal”, “top”, “bottom”, “inside”, and “outside”, are based on the orientation or positional relationship shown in the drawings, and are merely for the convenience of describing the embodiments of the present application and simplifying the description, rather than indicating or implying that the device or component stated must have a particular orientation, or be constructed and operated in a particular orientation, and thus cannot be understood as limitation to the embodiments of the present application. Furthermore, the terms “first”, “second”, “third” and the like are only used for descriptive purposes and should not be construed as indicating or implying a relative importance.

In the description of embodiments of the present application, it should be noted that, unless otherwise explicitly specified and defined, the terms “connected to” and “connected” shall be understood broadly. For example, it may be either fixedly connected or detachably connected, or may be integrally connected; it may be either mechanically connected, or electrically connected; it may be either directly connected, or indirectly connected through an intermediate medium. The specific meanings of the terms above in embodiments of the present application may be understood by those skilled in the art in accordance with specific conditions.

In the embodiments of the present application, unless otherwise clearly stated and defined, the first feature being located “on” or “under” the second feature means that the first feature is in direct contact with the second feature or the first feature is in contact with the second feature by an intermediate medium. In addition, the first feature is “on,” “above” and “over” the second feature can refer to that the first feature is directly above or obliquely above the second feature, or simply refer to that the level of the first feature is higher than that of the second feature. The first feature is “under”, “below” and “beneath” the second feature can refer to that the first feature is directly below or obliquely below the second feature, or simply refer to that the level of the first feature is lower than that of the second feature.

In the description of the present specification, description with reference to the terms “one embodiment,” “some embodiments,” “an example,” “specific example,” “some examples” and the like, refers to that specific features, structures, materials or characteristics described in combination with an embodiment or an example are included in at least one embodiment or example of the embodiments of the present application. In the present specification, the schematic expressions of the above terms are not necessarily directed to the same embodiment or example. Also, the described specific features, structures, materials or characteristics can be combined in any one or more embodiments or examples in a suitable manner. In addition, those skilled in the art may combine the different embodiments or examples described in this specification, as well as the features of the different embodiments or examples, without conflicting each other.

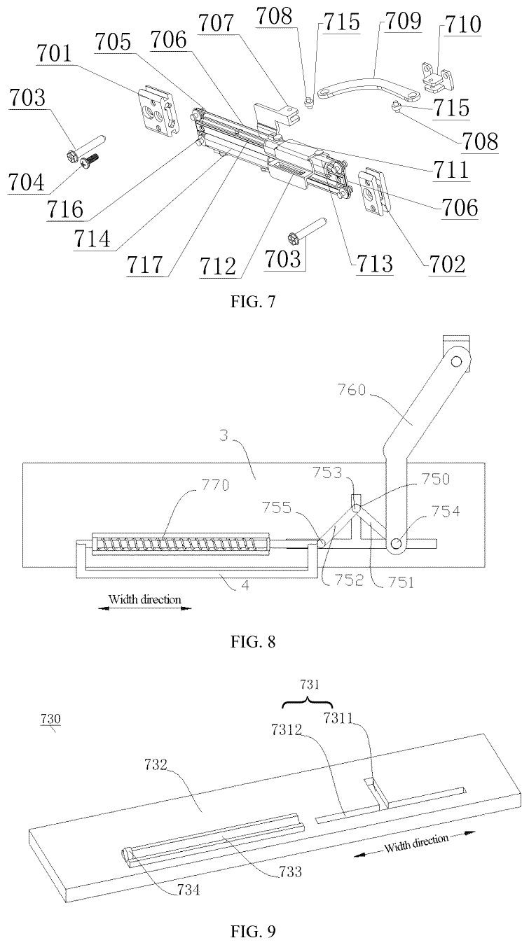

A door body assembly for an embedded refrigeration apparatus and a refrigeration apparatus according to the present application are described below in conjunction with FIG. 1 to FIG. 36.

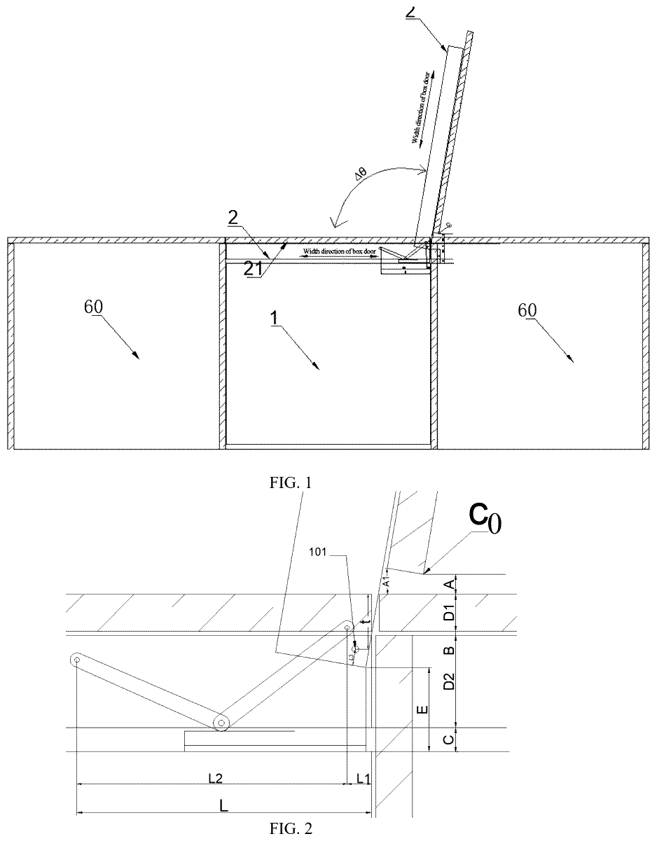

In an embodiment of the present application, as shown in FIG. 1 and FIG. 2, the door body assembly for the embedded refrigeration apparatus provided by the present application, as shown in FIG. 1, includes a box door 2 and a door panel 21. The box door 2 is rotatably connected to a refrigeration box body 1 to open or close a storage space inside the refrigeration box body 1. The refrigeration box body 1 is embedded into an accommodation space formed by a mount body. The mount body here generally refers to a cupboard 60. In an embodiment, the installation mount body can also be a corner of a wall, or the mount body can also refer to other components, as long as it can form an accommodating space. Description is made below by taking the mount body as the cupboard 60 as an example. The door panel 21 is movably mounted to the box door 2 and are movable along a width direction of the box door 2, the door panel 21 is suitable for moving toward a door-opening side relative to the box door 2 during opening process of the box door 2.

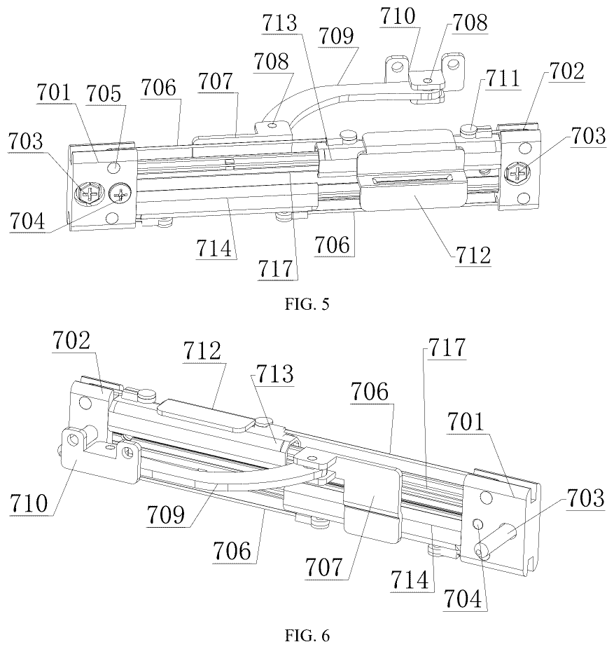

According to an embodiment of the present application, the door panel 21 is mounted to the box door 2 through a slide mechanism (referring to FIG. 4, a slide door mechanism 7 includes the slide mechanism and a traction mechanism, where the slide mechanism and traction mechanism are not separately labeled. The structure of the traction mechanism may be referred to as the traction rod 709 in FIG. 5, and the slide mechanism may be referred to as the first pedestal 717, a first slider 714, and second slider 713 in FIG. 5). The door panel 21 can move along the width of the box door 2 by a movement distance d. Specifically, the traction mechanism is connected to the slide mechanism, where during the box door 2 is opened or closed, the traction mechanism drives the slide mechanism to move to cause the door panel 21 to move relative to the box door 2. According to an embodiment of the present application, a maximum door opening angle of the door body assembly is 90° to 135°, and the movement distance d of the door panel is between 14.15 mm and 109.108 mm. The maximum door opening angle is positively correlated with a minimum value of the movement distance d. That is, the larger the maximum door opening angle, the larger the minimum value of the movement distance d. For example, when the maximum door opening angle is 96°, the minimum value of the movement distance dis 15.233 mm to 66.616 mm. When the maximum door opening angle is 135°, the minimum value of the required movement distance dis 67.883 mm to 109.108 mm.

According to an embodiment of the present application, when the maximum door opening angle is 90° to 135° and the minimum value of the movement distance d corresponding to the maximum door opening angle is between 14.15 mm and 109.108 mm, it can be ensured that the door panels do not interfere with each other, and the minimum value of the movement distance can be used as a reference standard for designing the slide mechanism to ensure that the obtained door body assembly can enhance user's experience.

According to an embodiment of the present application, to meet the usage requirements of the refrigeration apparatus and to maintain a unified style between the refrigeration apparatus and the mount body, in conjunction with FIG. 2, the thickness D1 of the door panel is generally 12 mm to 25 mm, and the thickness D2 of the cupboard door is generally 20 mm to 60 mm. It is noted that the numerical ranges here do not limit the embodiment of the present application.

According to an embodiment of the present application, to further ensure the usage safety of the door body assembly, in conjunction with FIG. 2, a safety gap A between an interference position of the door panel 21 at the maximum door opening angle and the panel of the mount body is from 1 mm to 5 mm. The interference position refers to a position of the door panel 21 where interference is most likely to occur on the hinge side, corresponding to the outer corner of the door panel 21 on the hinge side. In an embodiment, the gap between the interference position and the panel of the mount body can also be infinitely close to zero, which just ensures that there is no interference between the interference position and the panel of the mount body. The examples given here does not constitute a limitation to the gap between the interference position and the panel of the mount body. In addition, to facilitate the assembly of the door body assembly, a fit-up gap B between the door panel and the box door is 1 mm to 10 mm, and a gap C between the box door and the refrigeration box body is 3 mm to 15 mm. Similarly, the examples given here do not constitute a limitation to the door body assembly.

Based on the table below, the safety clearance A may be set to 1 mm, 3 mm, or 4 mm; the fit-up gap B may be set to 1 mm, 2 mm, 5.6 mm, or 10 mm; the fit-up gap C may be set to 3 mm, 4 mm, 8 mm, 10.5 mm, or 10 mm; the thickness of the door panel may be set to 12 mm, 18 mm, 20 mm, 21 mm, 22 mm, 23 mm, or 24 mm; and the thickness of the box door may be set to 20 mm, 23 mm, 33 mm, 38 mm, 40 mm, 45 mm, 47 mm, 52 mm, or 60 mm. At the maximum door opening angle, the distance from the bottom of the box door 2 to the refrigeration box body 1 may be set to 35.85 mm, 20 mm, or 30 mm. On this basis, different minimum movement distances may be obtained for different maximum door opening angles. Refer to the table below.

TABLE 1

| | Fit-up | | | | | | | |
|---|---|---|---|---|---|---|---|---|
| | gap B | | | | | | | |
| | between | Gap C | | | Dimension | | | |
| | door | between | | | E between | Maximum | | |
| | panel | box door | Thickness | Thickness | door panel | door | | |
| Safety | and box | and box | D1 of door | D2 of box | and box | opening | sin | |
| gap A | door | body | panel | door | body | angle W | (180°-W) | L2 |
| 1 | 1 | 4 | 12 | 20 | 35.85 | 96° | 0.9945 | 2.16189 |
| 1 | 1 | 4 | 12 | 33 | 35.85 | 96° | 0.9945 | 15.23379 |
| 1 | 1 | 4 | 12 | 38 | 35.85 | 96° | 0.9945 | 20.26144 |
| 3 | 5.6 | 10.5 | 23 | 50 | 35.85 | 96° | 0.9945 | 56.56109 |
| 3 | 5.6 | 10.5 | 23 | 52 | 35.85 | 96° | 0.9945 | 58.57215 |
| 3 | 5.6 | 10.5 | 23 | 60 | 35.85 | 96° | 0.9945 | 66.61639 |
| 3 | 5.6 | 10.5 | 23 | 50 | 35.85 | 100° | 0.9848 | 57.1182 |
| 3 | 5.6 | 10.5 | 23 | 52 | 35.85 | 100° | 0.9848 | 59.14907 |
| 3 | 5.6 | 10.5 | 23 | 60 | 35.85 | 100° | 0.9848 | 67.27254 |
| 3 | 5.6 | 10.5 | 23 | 50 | 35.85 | 115° | 0.9063 | 62.06554 |
| 3 | 5.6 | 10.5 | 23 | 52 | 35.85 | 115° | 0.9063 | 64.27232 |
| 3 | 5.6 | 10.5 | 23 | 60 | 35.85 | 115° | 0.9063 | 73.09942 |
| 3 | 5.6 | 10.5 | 23 | 50 | 35.85 | 120° | 0.9063 | 62.06554 |
| 3 | 5.6 | 10.5 | 23 | 52 | 35.85 | 120° | 0.9063 | 64.27232 |
| 3 | 5.6 | 10.5 | 23 | 60 | 35.85 | 120° | 0.9063 | 73.09942 |
| 3 | 5.6 | 10.5 | 23 | 50 | 35.85 | 135° | 0.7071 | 79.55028 |
| 3 | 5.6 | 10.5 | 23 | 52 | 35.85 | 135° | 0.7071 | 82.37873 |
| 3 | 5.6 | 10.5 | 23 | 60 | 35.85 | 135° | 0.7071 | 93.69255 |
| 4 | 10 | 15 | 24 | 33 | 35.85 | 96° | 0.9945 | 50.42735 |
| 4 | 10 | 15 | 24 | 38 | 35.85 | 96° | 0.9945 | 55.455 |
| 4 | 10 | 15 | 24 | 45 | 35.85 | 96° | 0.9945 | 62.49372 |
| 4 | 10 | 15 | 24 | 47 | 35.85 | 96° | 0.9945 | 64.50478 |
| 4 | 10 | 15 | 24 | 50 | 35.85 | 96° | 0.9945 | 67.52137 |
| 4 | 10 | 15 | 24 | 52 | 35.85 | 96° | 0.9945 | 69.53243 |
| 4 | 10 | 15 | 24 | 60 | 35.85 | 96° | 0.9945 | 77.57667 |
| 4 | 10 | 15 | 24 | 33 | 35.85 | 100° | 0.9848 | 50.92405 |
| 4 | 10 | 15 | 24 | 38 | 35.85 | 100° | 0.9848 | 56.00122 |
| 4 | 10 | 15 | 24 | 45 | 35.85 | 100° | 0.9848 | 63.10926 |
| 4 | 10 | 15 | 24 | 47 | 35.85 | 100° | 0.9848 | 65.14013 |
| 4 | 10 | 15 | 24 | 50 | 35.85 | 100° | 0.9848 | 68.18643 |
| 4 | 10 | 15 | 24 | 52 | 35.85 | 100° | 0.9848 | 70.2173 |
| 4 | 10 | 15 | 24 | 60 | 35.85 | 100° | 0.9848 | 78.34078 |
| 4 | 10 | 15 | 24 | 33 | 35.85 | 135° | 0.7071 | 70.92349 |
| 4 | 10 | 15 | 24 | 38 | 35.85 | 135° | 0.7071 | 77.99463 |
| 4 | 10 | 15 | 24 | 45 | 35.85 | 135° | 0.7071 | 87.89422 |
| 4 | 10 | 15 | 24 | 47 | 35.85 | 135° | 0.7071 | 90.72267 |
| 4 | 10 | 15 | 24 | 50 | 35.85 | 135° | 0.7071 | 94.96535 |
| 4 | 10 | 15 | 24 | 52 | 35.85 | 135° | 0.7071 | 97.79381 |
| 4 | 10 | 15 | 24 | 60 | 35.85 | 135° | 0.7071 | 109.1076 |

TABLE 3

| | Fit-up | | | | | | | |
|---|---|---|---|---|---|---|---|---|
| | gap B | | | | | | | |
| | between | Gap C | | | Dimension | | | |
| | door | between | | | E between | Maximum | | |
| | panel | box door | Thickness | Thickness | door panel | door | | |
| Safety | and box | and box | D1 of | D2 of box | and box | opening | sin | |
| gap A | door | body | door panel | door | body | angle W | (180°-W) | L2 |
| 3 | 2 | 8 | 24 | 47 | 30 | 105° | 0.9659 | 55.90640853 |
| 3 | 5.6 | 10.5 | 23 | 50 | 35.85 | 96° | 0.9945 | 56.56108597 |
| 3 | 5.6 | 10.5 | 23 | 52 | 35.85 | 96° | 0.9945 | 58.57214681 |
| 3 | 5.6 | 10.5 | 23 | 60 | 35.85 | 96° | 0.9945 | 66.61639015 |
| 3 | 5.6 | 10.5 | 23 | 50 | 35.85 | 100° | 0.9848 | 57.11819659 |
| 3 | 5.6 | 10.5 | 23 | 52 | 35.85 | 100° | 0.9848 | 59.1490658 |
| 3 | 5.6 | 10.5 | 23 | 60 | 35.85 | 100° | 0.9848 | 67.27254265 |
| 3 | 5.6 | 10.5 | 23 | 50 | 35.85 | 115° | 0.9063 | 62.06554121 |
| 3 | 5.6 | 10.5 | 23 | 52 | 35.85 | 115° | 0.9063 | 64.27231601 |
| 3 | 5.6 | 10.5 | 23 | 60 | 35.85 | 115° | 0.9063 | 73.0994152 |
| 3 | 5.6 | 10.5 | 23 | 50 | 35.85 | 120° | 0.866 | 64.95381062 |
| 3 | 5.6 | 10.5 | 23 | 52 | 35.85 | 120° | 0.866 | 67.26327945 |
| 3 | 5.6 | 10.5 | 23 | 60 | 35.85 | 120° | 0.866 | 76.50115473 |
| 3 | 5.6 | 10.5 | 23 | 50 | 35.85 | 135° | 0.7071 | 79.55027577 |
| 3 | 5.6 | 10.5 | 23 | 52 | 35.85 | 135° | 0.7071 | 82.37873002 |
| 3 | 5.6 | 10.5 | 23 | 60 | 35.85 | 135° | 0.7071 | 93.69254702 |
| 4 | 10 | 15 | 24 | 33 | 35.85 | 96° | 0.9945 | 50.42735043 |
| 4 | 10 | 15 | 24 | 38 | 35.85 | 96° | 0.9945 | 55.45500251 |
| 4 | 10 | 15 | 24 | 45 | 35.85 | 96° | 0.9945 | 62.49371543 |
| 4 | 10 | 15 | 24 | 47 | 35.85 | 96° | 0.9945 | 64.50477627 |
| 4 | 10 | 15 | 24 | 50 | 35.85 | 96° | 0.9945 | 67.52136752 |
| 4 | 10 | 15 | 24 | 52 | 35.85 | 96° | 0.9945 | 69.53242836 |
| 4 | 10 | 15 | 24 | 60 | 35.85 | 96° | 0.9945 | 77.57667169 |
| 4 | 10 | 15 | 24 | 33 | 35.85 | 100° | 0.9848 | 50.92404549 |
| 4 | 10 | 15 | 24 | 38 | 35.85 | 100° | 0.9848 | 56.00121852 |
| 4 | 10 | 15 | 24 | 45 | 35.85 | 100° | 0.9848 | 63.10926076 |
| 4 | 10 | 15 | 24 | 47 | 35.85 | 100° | 0.9848 | 65.14012998 |
| 4 | 10 | 15 | 24 | 50 | 35.85 | 100° | 0.9848 | 68.18643379 |
| 4 | 10 | 15 | 24 | 52 | 35.85 | 100° | 0.9848 | 70.21730301 |
| 4 | 10 | 15 | 24 | 60 | 35.85 | 100° | 0.9848 | 78.34077985 |
| 4 | 10 | 15 | 24 | 33 | 35.85 | 135° | 0.7071 | 70.92349031 |
| 4 | 10 | 15 | 24 | 38 | 35.85 | 135° | 0.7071 | 77.99462594 |
| 4 | 10 | 15 | 24 | 45 | 35.85 | 135° | 0.7071 | 87.89421581 |
| 4 | 10 | 15 | 24 | 47 | 35.85 | 135° | 0.7071 | 90.72267006 |
| 4 | 10 | 15 | 24 | 50 | 35.85 | 135° | 0.7071 | 94.96535144 |
| 4 | 10 | 15 | 24 | 52 | 35.85 | 135° | 0.7071 | 97.79380569 |
| 4 | 10 | 15 | 24 | 60 | 35.85 | 135° | 0.7071 | 109.1076227 |

The data with a gray background in Table 2 above is the preferred data. Specifically, it corresponds to a safety gap A of 3 mm, a fit-up gap B of 2 mm, a gap C of 8 mm, the thickness D1 of the door panel of 18 mm, thickness D2 of the box door of 23 mm to 60 mm, a dimension E of 30 mm, and a maximum door opening angle of 96° to 135°. Accordingly, the value of L2 ranges from 24.133 mm to 67.883 mm.

According to an embodiment of the present application, in conjunction with FIG. 2, when the opening angle of the box door 2 is an angle of 90°, the movement distance is d1, and d1 is not less than the sum of the distance t and the distance l3, where tis a distance between the hinge shaft center of the box door 2 and the opening of the accommodation space, and l3 is a vertical distance between the hinge shaft center 101 of the box door 2 and an end surface of the door panel 21 on the hinge side. In the above case, that is, once the opening angle of the box door 2 is an angle of 90°, the door panel 21 is completely beyond the accommodation space to obviously avoid interference between the door panel 21 and the inner wall of the accommodation space. At this time, it is equivalent to the end surface of the door panel 21 on the hinge side being beyond the mount body, to further avoid interference between the end surface of the door panel 21 on the hinge side and the outer surface of the mount body.

Based on the above, if the maximum door opening angle is greater than 90°, to ensure that the door panel 21 does not interfere during opening process of the door body assembly, it is necessary to further ensure that d-t-l3 is not less than a distance that the interference position of the door panel 21 moves toward the cupboard body along the depth direction of the accommodation space after 90°. The depth direction of the accommodation space is perpendicular to the width direction of the box door (as indicated by the arrow in FIG. 1) when the box door is closed. Referring to FIG. 2, the door panel 21 has an interference position point c0, which is located at an outer corner of the door panel 21 on the hinge side. “Outer” is relative to the refrigeration box body 1. The side facing away from the refrigeration box body 1 is the “outer” side and the side facing the refrigeration box body 1 is the “inner” side. Since FIG. 2 is a top view, the interference position is one point in FIG. 2. For the door body assembly, the interference position is a vertical line. Similarly, if the outer corner of the door panel 21 on the hinge side is arc-shaped, the interference position is the point on the arc-shaped segment farthest from the hinge shaft center 101 of the box door 2.

According to an embodiment of the present application, the maximum door opening angle Δθ is between 90° and 135°, that is, 90°≤Δθ≤135°. At this door opening angle, all user's pickup and placement requirements can be met, and the opened door panel 21 does not occupy too much usable space. In an embodiment, the maximum door opening angle Δθ may also be other values.

According to an embodiment of the present application, after the interference position moves away from the accommodation space and aligns with the mount body, a distance between the interference position and the panel of the mount body is A, and A>0. In other words, when the interference position moves away from the area corresponding to the accommodation space and moves toward the second cupboard panel 602 on the right side of the cupboard 60, to prevent interference, the distance A between the interference position and the outer surface of the second cupboard panel 602 is always greater than zero.

According to another embodiment of the present application, in conjunction with FIG. 2, the movement distance d of the door panel 21 and the maximum door opening angle Δθ of the door body assembly satisfy:

$$d = ( A + B + C + D 1 + D 2 - E ) / sin ( 180 - Δθ ) .$$

A1 is the safety gap between a corner corresponding to the interference position of the door panel 21 and the panel of the mount body at the maximum door opening angle, B is the fit-up gap between the door panel 21 and the box door 2, C is the gap between the box door 2 and the refrigeration box body 1, D1 is a thickness of the door panel 21, D2 is a thickness of the box door 2, and E is a distance between an innermost corner of the box door 2 and the refrigeration box body 1 at the maximum door opening angle. A1, B, C, D1, and D2 are known and the relationship between d and Δθ can be derived. E can be directly a given design value, or can be L3/sin(180−Δθ), where L3 is a distance between a shaft center of a hinge of the slide rail and an outer surface of the box door It is noted that l3 is different from L3, l3 is indicated in the drawing, and L3 is perpendicular to l3.

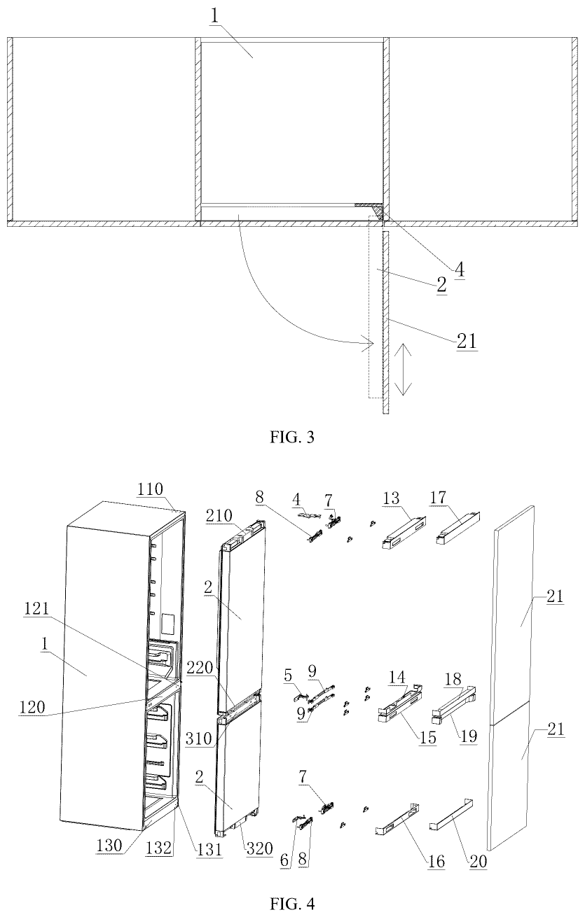

In FIG. 3 and FIG. 4, a slide mechanism 4 is connected between the door panel 21 and the box door 2. The slide mechanism 4 is connected to the traction mechanism, and the door panel 21 is driven to move relative to the box door 2 under the driving of the traction mechanism. The slide mechanism 4 includes a slide rail and a slider moving along the slide rail (the structure of the slide mechanism 4 is described below with examples).

In a case that the traction mechanism is a link mechanism, if the transmission ratio of the link mechanism is 1:1, a movement distance L2 of a hinge shaft connecting the link mechanism and the traction mechanism is the movement distance d of the door panel 21 relative to the box door 2.

In FIG. 2, it is assumed that when the door body assembly is in a closed position, an outermost distance between an end surface of the refrigeration box body 1 on the hinge side and the hinge shaft is L, that is, the maximum distance between the end surface of the door panel 21 on the hinge side and the hinge shaft is L. At the maximum door opening angle, a distance between an end surface of the refrigeration box body 1 on the hinge side and the hinge shaft is L1, where L1 is a designed amount, and a displacement of the hinge shaft of the refrigerator door 2 from opening to the maximum door opening angle is L2 (maximum slip amount).

L2=d=(A1+B+C+D1+D2−E)/sin(180−Δθ), and the relationship between the maximum door opening angle Δθ and L2 can then be obtained when other parameters are determined.

According to embodiments of the present application, the difference between A1 and A can be ignored, and A1 in the formula may be replaced with A, where A represents the safety gap between the interference point of door panel 21 and the panel of the mount body at the maximum door opening angle. A1=A+D1×cos(180−Δθ). As long as A falls within a certain range, L2 calculated based on L2=d=(A+B+C+D1+D2−E)/sin(180−Δθ) can meet the requirements. For example, if A is between 1 and 5 mm, the calculated movement distance L2 can meet the non-interference requirement.

Similarly, the above formula for d and the maximum door opening angle of the door body assembly does not constitute limitation. For example, the above formula may also include correction coefficients or correction parameters. Furthermore, the above formulas are based on a known hinge shaft center 101 of the box door 2. If the box door 2 is mounted using biaxial hinges or movable hinges, the hinge shaft center 101 will change as the box door 2 is opened. Consequently, the movement distance of the hinge shaft center 101 needs to be calculated.

According to an embodiment of the present application, the slide door mechanism 7 includes a slide mechanism and a traction mechanism.

According to an embodiment of the present application, as shown in FIG. 4 and FIG. 5, the slide mechanism includes: a first pedestal 717, a first slider 714, a second slider 713, and a flexible cable 706. A first side of the first pedestal 717 is formed with a first guide rail and a second side of the first pedestal 717 is formed with a second guide rail. The first slider 714 is slidably provided at the first guide rail, and the traction mechanism is rotatably connected between the box body 1 and the first slider 717. The second slider 713 is slidably provided at the second guide rail and is connected to the door panel 21. Two ends of the flexible cable 706 are connected to the first slider 714 and the second slider 713, respectively. In a case that the first slider 714 moves at the first guide rail, the first slider 714 drives the second slider 713 in the opposite direction at the second guide rail through the flexible cable 706 to drive the door panel 21 relative to a width direction of the box door 2.

The slide mechanism of the present embodiment may be provided at the box door 2. One of the first slider 714 and the second slider 713 is in transmission connection with the box door 2 or the box body 1, while the other of the first slider 714 and the second slider 713 is slidably connected to the door panel 21 located outside the box door 2. When the box door 2 rotates, the first slider 714 and the second slider 713 slide relative to each other to drive the door panel 21 to slide relative to the box door 2, allowing the door panel 21 to avoid obstacles on either side during opening and closing process of the box door 2.

Specifically, a first slider 714 being connected to the box body 1 through the traction mechanism and a second slider 713 being connected to the door panel 21 are taken as an example and the first pedestal 717 of the present embodiment may be provided at the box door 2. Two ends of the flexible cable 706 are connected to the first slider 714 and second slider 713, respectively. This allows the first slider 714 to pull the second slider 713 through the flexible cable 706 for synchronously moving to drive the door panel 21 to slide relative to the box door 2.

By properly configuring an extension direction of the flexible cable 706, the first slider 714 and second slider 713 move in opposite directions to drive the door panel 21 to avoid obstacles.

For example, when the box door 2 is rotated toward the outside of the box body 1 and is opened, the box door 2 drives the first slider 714 through the traction mechanism to slide in a direction close to the first hinge 4. Simultaneously, the first slider 714 drives the second slider 713 through the flexible cable 706 in the opposite direction (i.e., away from the first hinge 4), preventing the door panel 21 from interfering with external obstacles. During a process that the box door 2 is rotated toward a side of the box body 1 and is closed, the box body 1 drives the first slider 714 to slide in a direction away from the first hinge 4. Simultaneously, the first slider 714 drives the second slider 713 through the flexible cable 706 in the opposite direction (i.e., close to the first hinge 4), preventing the door panel 21 from interfering with external obstacles after the box door 2 is closed.

The first slider 714 may also be connected to the door panel 21. Correspondingly, the second slider 713 is connected to the box door 2 or box body 1 through a traction mechanism. The process is identical to that of the previous embodiment and is not further described here.

In the slide mechanism of the present embodiment, by providing the first guide rail and the second guide rail at either side of a first pedestal 717, the first slider 714 and the second slider 713 are slidably provided at the first guide rail and the second guide rail, respectively. Driven by a flexible cable 706, the first slider 714 and second slider 713 may slide synchronously along their respective guide rails in opposite directions. One of the first slider 714 and second slider 713 is in the box door 2 or the box body 1 in a manner through a traction mechanism, while the other is in transmission connection with the door panel 21 provided outside the box door 2. As the box door 2 rotates, the two sliders slide relative to each other to drive the door panel 21 to slide relative to the box door 2 and allow the door panel 21 to avoid obstacles on either side during opening and closing of the box door 2.

In actual applications, the design of the first slider 714 and second slider 713 may be flexible and adaptable to different operating scenarios and performance requirements. They are not limited to specific shapes, sizes, or materials and may be customized and optimized based on specific needs.

From a material perspective, the first slider 714 and second slider 713 may be made of materials with high wear resistance, low friction coefficient, and good stability, such as metal alloys, engineering plastics, or special lubricants. These materials are selected to enhance the durability of the sliders, reduce wear and noise during sliding, and ensure smooth sliding.

In terms of structural design, the first slider 714 and second slider 713 may utilize a variety of guide rail contact surfaces, such as flat contact, ball contact, or sliding bearing contact. Each of these contact methods has its advantages and disadvantages. For example, ball contact reduces friction and wear but is more expensive, while flat contact offers a simpler structure but may require more frequent lubrication and maintenance. Therefore, factors such as usage conditions, cost-effectiveness, and ease of maintenance should be comprehensively considered during the selection process.

In addition, to enhance the load-bearing capacity and stability of the sliders, reinforcement ribs, support plates, or other auxiliary structures may be added to the first slider 714 and second slider 713. These structures increase the rigidity and deformation resistance of the sliders, ensures stable sliding performance when bearing the weight of the door panel 21 and external forces.

In the present embodiment, the first guide rail and the second guide rail are provided sequentially along a width direction of the first pedestal 717, and the first guide rail and the second guide rail are provided in parallel to each other along width direction of the first pedestal 717. This ensures that the lengths of the first guide rail and the second guide rail meet the sliding distances of the first slider 714 and second slider 713, effectively reduces the height and thickness of the first pedestal 717. This results in a more compact structure and smaller occupation space.

In actual applications, due to factors such as machine tool accuracy, tool wear, and material unevenness, machining errors in the first guide rail and the second guide rail and the base may occur. These errors may include dimensional errors (such as length, width, and height deviations), shape errors (such as straightness, flatness, and roundness), and positional errors (such as coaxiality, parallelism, and perpendicularity). The parallelism between the first guide rail and the second guide rail is assessed by measuring their relative positional deviation. This deviation must be kept within a certain tolerance range to ensure smooth sliding of the sliders and stable operation of the system. This tolerance range is generally determined based on design requirements, operating environment, and accuracy of the system.

In the present embodiment, the terms “parallel” and “perpendicular” should not be strictly defined in a geometric sense. At least manufacturing and mounting tolerances should be considered, and a tolerance of plus or minus 10° should be considered within the scope of patent protection.

According to an embodiment of the present application, as shown in FIG. 5, the flexible cable 706 includes a first flexible cable and a second flexible cable. The first flexible cable bypasses a first end of the first pedestal 717 and two ends of the first flexible cable are connected to a first end of the first slider 714 and the second slider 713, respectively. The second flexible cable bypasses a second end of the first pedestal 717 and two ends of the first flexible cable are connected to a second end of the first slider 714 and the second slider 713, respectively.

In the present embodiment, the first flexible cable bypasses a first end of the first pedestal 717 and connected to the first slider 714 and the second slider 713 respectively. When the first slider 714 slides in a direction away from the end of the first pedestal 717 under the drive of the box door 2 or the box body 1 through the traction mechanism, the first slider 714 drives the second slider 713 to slide in a direction close to the end of the first pedestal 717 through the first flexible cable. At the same time, the second flexible cable bypasses a second end of the first pedestal 717 and connected to the first slider 714 and the second slider 713 respectively. When the first slider 714 slides in a direction away from a second end of the first pedestal 717 under the drive of the box door 2, the first slider 714 drives the second slider 713 to slide in a direction closer to of a second end of the first pedestal 717 through the second flexible cable. This ensures that when the first slider 714 slides toward either end of the first pedestal 717, the second slider 713 and the first slider 714 are driven to slide in the opposite direction. This allows the door panel 21 to slide relative to the box door 2 as it rotates when the box door 2 is opened and closed, preventing interference with obstacles that could affect the opening and closing of the box door 2.

The flexible cable 706 is one of a steel wire rope, steel stranded wire, or hemp rope. The selection of the flexible cable 706 depends on the load it must withstand, the operating environment, and the intended use. Steel wire rope or steel stranded wire is recommended for applications requiring heavy loads and harsh environments; hemp rope may be considered for applications with lighter loads and milder environments. Under the premise of satisfying the intended use, the cost differences between different materials are considered and the most cost-effective material is selected. Furthermore, the steel wire ropes and steel stranded wire may require regular inspection and maintenance during use to ensure their performance and safety; hemp ropes, on the other hand, are relatively easy to replace and maintain.

Specifically, both the second slider 713 and the first slider 714 are provided with a connector 711 for fixing the flexible cable 706.

In an embodiment of the present application, as shown in FIG. 5, the slide mechanism further includes: a first fixation base 701 and a second fixation base 702. The first fixation base 701 is connected to a first end of the first pedestal 717 and is formed with a first limit slot. Two ends of the first limit slot abut against a first end of the first guide rail and second guide rail, and a part of the first flexible cable is slidably provided at the first limit slot. The second fixation base 702 is connected to a second end of the first pedestal 717 and formed with a second limit slot. Two ends of the second limit slot abut against a second end of the first guide rail and second guide rail, and a part of the first flexible cable is slidably provided at the second limit slot.

In the present embodiment, the first fixation base 701 and the second fixation base 702 are respectively provided at two ends of the first pedestal 717, and the first fixation base 701 and the second fixation base 702 are respectively formed with the first limit slot and the second limit slot abutting against the first guide rail and the second guide rail for respectively limiting and guiding the positions of the first flexible rope and the second flexible rope, and thus the first flexible rope and the second flexible rope smoothly slide.

Specifically, the first fixation base 701 is provided with a first fixation hole, and the first pedestal 717 is provided with a first waist-type hole extending along a width direction of the first pedestal 717. The slide mechanism further includes a first adjustment member 704 and the first adjustment member 704 penetrates through the first fixation hole and is slidably provided at the first waist-type hole to adjust a degree of tension of the first flexible cable by adjusting a position of the first adjustment member 704 within the first waist-type hole.

In the present embodiment, by adjusting the position of the first adjustment member 704 within the first waist-type hole, the position of the first fixation base 701 may be adjusted along the width of the first pedestal 717, and the first fixation base 701 can tighten or loosen the first flexible cable, adjusting a degree of tension of the first flexible cable.

Since the first flexible cable and second flexible cable are located at the first fixation base 701 and the second fixation base 702 on either side of the first pedestal 717, respectively, and are connected to two ends of the first slider 714 and second slider 713, when the movement of the first fixation base 701 relative to the first pedestal 717 is adjusted through the first waist-type hole, a degree of tension of the first flexible cable is adjusted accordingly, and a degree of tension of the second flexible cable is also adjusted accordingly as the first fixation base 701 pulls on the first flexible cable.

The second fixation base 702 may be also provided with a first fixation hole, and the first pedestal 717 is provided with a first waist-type hole extending along a width direction of the first pedestal 717. The slide mechanism further includes a first adjustment member 704 and the first adjustment member 704 penetrates through the first fixation hole and is slidably provided at the first waist-type hole to adjust a degree of tension of the second flexible cable by adjusting a position of the first adjustment member 704 within the first waist-type hole.

In the present embodiment, by adjusting the position of the first adjustment member 704 within the first waist-type hole, the position of the second fixation base 702 may be adjusted along the width of the first pedestal 717, and the second fixation base 702 can tighten or loosen the second flexible cable, adjusting a degree of tension of the second flexible cable.

Since the first flexible cable and second flexible cable are located at the first fixation base 701 and the second fixation base 702 on either side of the first pedestal 717, respectively, and are connected to two ends of the first slider 714 and second slider 713, when the movement of the second fixation base 702 relative to the first pedestal 717 is adjusted through the first waist-type hole, a degree of tension of the second flexible cable is adjusted accordingly, and a degree of tension of the first flexible cable is also adjusted accordingly as the second fixation base 702 pulls on the second flexible cable.

Furthermore, in some embodiments, the first fixation base 701 is provided with a second waist-type hole extending along a width direction of the first pedestal 717. The first pedestal 717 is provided with a second fixation hole. The slide mechanism further includes a second adjustment member 703, and the second adjustment member 703 sequentially penetrates through the second waist-type hole and the second fixation hole to be fixed to an external structure to adjust a position of the first fixation base 701 relative to the external structure by adjusting a position of the second adjustment member 703 in the second waist-type hole.

In the present embodiment, by providing a second waist-type hole in the first fixation base 701 and sequentially penetrating the second adjustment member 703 through the second waist-type hole and the second fixation hole to fix it in the external structure, the first fixation base 701 is fixed in the external structure to fix the slide mechanism to the external structure (such as the box door 2). Furthermore, the second adjustment member 703 may be fine-tuned along the second waist-type hole to adjust the position of the first fixation base 701, adjusting the position of the first fixation base 701 relative to the external structure.

The second fixation base 702 may further be provided with a second waist-type hole extending along the width direction of the first pedestal 717. The second adjustment member 703 sequentially penetrates through the second waist-type hole and the second fixation hole to be fixed to the external structure to adjust a position of the second fixation base 702 relative to the external structure by adjusting a position of the second adjustment member 703 in the second waist-type hole. The functions of the second adjustment member 703, the second waist-type hole, and the second fixation hole are similar to those in the above-described embodiment and is not further described here.

Furthermore, in some embodiments, a rotatable support bearing is provided in the first limit slot; and a part of the first flexible cable abuts against the support bearing in the first limit slot. In the present embodiment, by abutting a part of the first flexible cable against the support bearing, the movement and extension direction of the first flexible cable is adjusted to facilitate the first flexible cable to bypass an end of the first pedestal 717 to be connected to the first slider 714 and the second slider 713.

The second limit slot may be also provided with a rotatable support bearing. A part of the second flexible cable abuts against the support bearing in the second limit slot to adjust an extension direction of the second flexible cable and to facilitate the second flexible cable to bypass the end of the first pedestal 717 to be connected to the first slider 714 and the second slider 713.

Specifically, in some embodiments, the support bearing includes a first bearing 705 and a second bearing 716. The first bearing 705 and the second bearing 716 are respectively located at a first end of the first guide rail and the second guide rail on the same side and at two sides of the first pedestal 717.

In an embodiment of the present application, as shown in FIG. 5, the traction mechanism includes a traction rod 709, a first rotary shaft fixation base 707, and a second rotary shaft fixation base 710. The first rotary shaft fixation base 707 is connected to the first slider 714, and the second rotary shaft fixation base 710 is connected to the box body 1. A first end of the traction rod 709 is rotatably connected to the first rotary shaft fixation base 707, and a second end of the traction rod 709 is rotatably connected to the second rotary shaft fixation base 710.

In the present embodiment, by fixing the first rotary shaft fixation base 707 and second rotary shaft fixation base 710 to the first slider 714 and the box body 1 respectively, and connecting the first rotary shaft fixation base 707 to second rotary shaft fixation base 710 through the traction rod 709, a distance between the first slider 714 and the second rotary shaft fixation base 710 remains constant. When the box door 2 rotates relative to the box body 1, the angle between the box body 1 and the box door 2 changes. The first slider 714 is pulled by the transmission connection between the traction rod 709, the first rotary shaft fixation base 707 and second rotary shaft fixation base 710, the first slider 714 slides on the first pedestal 717 to drive the second slider 713 to slide in turn and move the door panel 21 relative to the box door 2.

Specifically, a first end of the traction rod 709 is rotatably connected to the first rotary shaft fixation base 707 through a pin 708 and a third bearing 715, while a second end of the traction rod 709 is rotatably connected to the second rotary shaft fixation base 710 through another pin 708 and another third bearing 715.

In another embodiment of the present application, as shown in FIG. 3 and FIG. 4, a door body assembly is provided, including: a box door 2, a door panel 21, and the slide mechanism as provided in any of the aforementioned embodiments. The box door 2 is rotatably connected to the box body 1, suitable for opening or closing a storage space of the box body 1. The door panel 21 is slidably provided at the outside of the box door 2. The slide mechanism is provided at the box door 2, a first slider 714 is in transmission connection with the box body 1, and a second slider 713 is connected to the door panel 21. During the opening or closing process of the box door 2, the first slider 714 and the second slider 713 move in opposite directions to drive the door panel 21 to move relative to the box door 2.

Specifically, during a process that the box door 2 is rotated toward the outside of the box body 1 and is opened, the first slider 714 slides in a direction close to the first hinge 4 driven by the box door 2 through the traction mechanism to drive the door panel 21 to slide in a direction away from the first hinge 4, preventing the door panel 21 from interfering with external obstacles. Similarly, during a process that the box door 2 is rotated toward a side of the box body 1 and is closed, the slide mechanism drives the door panel 21 to slide toward the first hinge 4, preventing the door panel 21 from interfering with obstacles after the box door 2 is closed.

According to the door body assembly of the present embodiment of the present application, a slide mechanism is provided at the box door 2. The slide mechanism is connected to the box door 2 and the door panel 21, respectively to drive the door panel 21 to slide in the width direction of the box door 2 during a process that the box door 2 is rotated relative to the box body 1 and is opened and closed, and the door panel 21 may avoid obstacles such as walls and objects when the box door 2 is closed or opened.

Since the slide mechanism exhibits the beneficial effects of the above-described embodiment, then the door body assembly also exhibits the beneficial effects of the above-described embodiment. The specific implementation thereof will be referred to the above-described embodiment and is not further described herein.

In an embodiment of the present application, as shown in FIG. 5 and FIG. 6, the second slider 713 is provided with a first connection block 712. The first connection block 712 is formed with a slot to which the door panel 21 is hanged.

In the present embodiment, by providing the first connection block 712 at the second slider 713 and providing the slot at the first connection block 712, the door panel 21 is also provided with a corresponding connection component (such as a hook or insert) matched with the slot to mount the door panel 21 at the first connection block 712 and the door panel 21 may slide along the second slider 713. This also facilitates the user to remove the door panel 21 from the second slider 713 when needed, meeting the user's needs in various scenarios.

According to another embodiment of the present application, in addition to the above-described dual-guide rail and dual-slider structure, the slide mechanism of the present application may further adopt the structures shown in FIG. 8 to FIG. 10. The slide mechanism includes a guide 730, a slide member 740, a link assembly 750, and a drive rod 760.

The guide 730 is provided at the box door and is provided with a guide structure 731. The slide member 740 is provided at the door panel and is movably provided at the guide 730 along the width direction of the box door.

The link assembly 750 is movably provided at the guide structure 731 and may be deformed under the guidance of the guide structure 731. A second end of the link assembly 750 is movably connected to the slide member 740.

The drive rod 760 is provided at the box body and movably connected to a first end of the link assembly 750. This drives the link assembly 750 to be deformed during the door opening and closing process to drive the slide member 740 to move the door panel along the width direction through the link assembly 750.

As shown in the drawing the box body is provided at a hinge with a hinge shaft. The box door is rotatably provided at the hinge shaft to open or close the box door relative to the box body.

The guide structure 731 ensures that the link assembly 750 moves along a predetermined path or direction, preventing it from deviating from a predetermined trajectory. It also guides the structural deformation of the link assembly 750 to drive the slide member 740 to move along the width direction of the box door.

Alternatively, the guide structure 731 may guide the link assembly 750 along the teeth of a sprocket by matching the sprocket with a chain. Alternatively, the guide structure 731 may guide the link assembly 750 along the cross-section of the guide rail by matching the slide block 742 with a guide rail.

Through the structural deformation of the link assembly 750, a gap between the second end the link assembly 750 and the hinge changes to change a gap between the slide member 740 and the hinge in turn, further changing a distance between the door panel connected to the slide member 740 and the hinge.

Alternatively, the link assembly 750 may be a parallelogram linkage or a crank-rocker mechanism.

In the slide mechanism shown in the present embodiment, by providing the guide 730 at the box door, and a slide member 740 at the door panel, the slide member 740 is movably provided at the guide 730 along the width direction of the box door. By providing the guide structure 731 at the guide 730, the guide structure 731 guides the structural deformation of the link assembly 750 and movably connects the second end of the link assembly 750 to the slide member 740. When the box door is opened, the drive rod 760 drives the first end of the link assembly 750, and the link assembly 750 is deformed structurally. The second end of the link assembly 750 pulls the slide member 740 to move away from the hinge to further drive the door panel to move in a direction away from the hinge along the width of the box door, preventing interference between the door panel and a cupboard at a side. When the box door is closed, the drive rod 760 drives the first end of the link assembly 750, and the link assembly 750 is deformed structurally. The second end of the link assembly 750 pulls the slide member 740 to move in a direction close to the hinge to further drive the door panel to move in a direction close to the hinge along the width of the box door and to restore the door panel to its original position, ensuring that the door panel does not interfere with the cupboards surrounding the refrigeration apparatus.

In some embodiments, as shown in FIG. 8, the link assembly 750 includes a first link 751 and a second link 752.

The drive rod 760 is rotatably connected to a first end of the first link 751. A second end of the first link 751 is rotatably connected to a first end of the second link 752 through a first hinge shaft 753. The first hinge shaft 753 is provided at the guide structure 731 and moves along a thickness direction of the door panel under the guidance of the guide structure 731 and a second end of the second link 752 is rotatably connected to the slide member 740.

The drive rod 760 is configured to drive the first end of the first link 751 to move along the width direction. The first link 751 is configured to drive the first hinge shaft 753 to move along the thickness direction to change an angle between the first link 751 and the second link 752. Consequently, the second link 752 drives the slide member 740 to move in a direction opposite to the driving direction of the drive rod 760.

The drive rod 760 provides a driving force to the first end of the first link 751 and the guide structure 731 may limit a movement path of the first hinge shaft 753 to allow the first hinge shaft 753 to move only along the thickness direction of the box door. This in turn changes the angle between the first link 751 and the second link 752 to allow the second link 752 to move along the width direction.

During an opening process of the box door, the drive rod 760 drives the first end of the first link 751 to move along the width direction in a direction close to the hinge. The first link 751 drives the first hinge shaft 753 to move along the thickness direction in a direction close to the slide member 740 to increase the angle between the first link 751 and the second link 752. The second link 752 is pushed to move in a direction away from the hinge to in turn drive the slide member 740 along the width direction in a direction away from the hinge, preventing interference between the door panel and the cupboard.

During the box door closing process, the drive rod 760 drives the first end of the first link 751 to move along the width direction in a direction away from the hinge. The first link 751 drives the first hinge shaft 753 to move along the thickness direction in a direction away from the slide member 740 to decrease the angle between the first link 751 and the second link 752. The second link 752 is pushed to move in a direction close to the hinge to in turn drive the slide member 740 along the width direction in a direction close to the hinge to restore the door panel to its original position, ensuring that the door panel does not interfere with the cupboards surrounding the refrigeration apparatus.

In the present embodiment, by providing the first link 751, the second link 752, and the first hinge shaft center 753 in the link assembly 750 and by limiting the movement of the first hinge shaft center 753 in the thickness direction, the angle between the first link 751 and the second link 752 is changed to allow the second link 752 to drive the slide member 740 in the width direction, thereby achieving movement of the door panel relative to the box door. This results in a simple structure and a compact size.

In some embodiments, as shown in FIG. 8, the drive rod 760 includes a linkage member.

A first end of the linkage member is rotatably provided at a fixed position on the box body of the refrigeration apparatus, and a second end of the linkage member is rotatably connected to the first end of the first link 751. The fixed position is provided offset from a hinge position between the box door and the box body.

During the box door opening process, the linkage member drives the first end of the first link 751 to move toward a side close to the hinge position, and the second link 752 drives the slide member 740 to move the door panel toward a side away from the hinge position.

During the box door closing process, the linkage member drives the first end of the first link 751 to move toward a side away from the hinge position, and the second link 752 drives the slide member 740 to move the door panel toward a side close to the hinge position.

In the present embodiment, the first end of the linkage member is rotatably provided at the hinge. When the box door rotates relative to the box body about the hinge shaft, the second end of the linkage member rotates in a circular motion centered at the hinge shaft. Since the first end of the linkage member is provided offset from the hinge shaft, a distance between the second end of the linkage member and the hinge changes as the linkage member rotates to drive the link assembly 750 close to or away from the hinge along the width of the box door.

During the box door opening process, the box door rotates to drive the linkage member to rotate. The second end of the linkage member drives the first end of the first link 751 to move toward a side close to the hinge position. The second end of the second link 752 drives the slide member 740 to move toward a side away from the hinge position, causing the door panel to move toward a side away from the hinge position.

During the box door closing process, the box door rotates to drive the linkage member to rotate. The second end of the linkage member drives the first end of the first link 751 to move toward a side away from the hinge position. The second end of the second link 752 drives the slide member 740 to move toward a side away from the hinge position, causing the door panel to move toward a side close to the hinge position.

In the present embodiment, by providing the first end of the linkage member offset from the hinge position between the box door and the box body, the second end of the linkage member may drive the first end of the first link 751 to in turn drives the second link 752 to move the slide member 740 in the width direction. The opening and closing of the box door controls the linkage member to drive the transmission of link assembly 750, and the slide member 740 may drive the door panel to move in the width direction without an additional drive device to allow the movement of the door panel relative to the box door to be synchronized with the opening and closing of the box door.

In some embodiments, as shown in FIG. 9, the guide structure 731 includes a first limit slot 7311.

The first limit slot 7311 extends in the thickness direction.

The first hinge shaft 753 is inserted into the first limit slot 7311 and is movable along the extension direction of the first limit slot 7311.

The first limit slot 7311 is configured to limit the first hinge shaft 753 to allow the first hinge shaft 753 to move only in the thickness direction. This allows the angle between the first link 751 and the second link 752, respectively connected to the first hinge shaft 753 to change and the second end of the first link 751 and the second end of the second link 752 move in opposite directions.

In the present embodiment, the first limit slot 7311 guides the movement of the first hinge shaft 753. Furthermore, the first limit slot 7311 may be directly formed at the upper surface of the guide 730, without occupying additional space and ensuring a compact structure for the slide mechanism.

In some embodiments, as shown in FIG. 9, the guide structure 731 further includes a second limit slot 7312.

The second limit slot 7312 extends in the thickness direction and communicates with the first limit slot 7311.

The drive rod 760 is rotatably connected to the first end of the first link 751 through a second hinge shaft 754 and the second end of the second link 752 is rotatably connected to the slide member 740 through a third hinge shaft 755. The second hinge shaft 754 and the third hinge shaft 755 are respectively inserted into the second limit slot 7312 and are movable along the extension direction of the second limit slot 7312.

The second hinge shaft 754 and the third hinge shaft 755 are respectively located at either side of the first limit slot 7311.

The second limit slot 7312 is configured to limit the second hinge shaft 754 and the third hinge shaft 755 to allowing them to move only in the width direction. This allows the second link 752 to drive the slide member 740 in this direction. In the present embodiment, the second limit slot 7312 prevents deviation in the direction of movement of the slide member 740, ensuring the reliable and stable movement of the slide member 740 and, consequently, the reliable movement of the door panel along the width direction of the box door.

In some embodiments, as shown in FIG. 8, the slide mechanism further includes an elastic member 770.

The elastic member 770 is provided between the guide 730 and the slide member 740.

When the link assembly 750 drives the slide member 740 to move toward the side away from the hinge position, the slide member 740 compresses the elastic member 770 while moving the door panel.

When the link assembly 750 drives the slide member 740 to move toward the side close to the hinge position, the elastic member 770 drives the slide member 740 to move the door panel toward the hinge position.

The hinge position is located between the box door and the box body, and the box door is rotatably provided at the box body about the hinge position.

When the link assembly 750 drives the slide member 740 to move toward the side away from the hinge position, the elastic member 770 is compressed in a direction away from the hinge and accumulates elastic potential energy.

When the link assembly 750 drives the slide member 740 to move toward the side close to the hinge position, the elastic potential energy of the elastic member 770 is released, and the elastic force of the elastic member 770 acts at the slide member 740 to drive the slide member 740 toward the hinge position.

Specifically, the elastic member 770 may be an elastic sheet, an elastic block, or a spring.

In the present embodiment, by providing the elastic member 770 at the slide mechanism, more stable and reliable movement of the slide member 740 relative to the guide 730 can be ensured based on the elastic deformation of the elastic member 770.

In some embodiments, as shown in FIG. 8 to FIG. 10, the guide 730 includes a fixation panel 732 and a slide recess 733.

The fixation panel 732 is provided at the box door.

The slide recess 733 is provided at the fixation panel 732 and extends along the width direction. At least a part of the slide member 740 is movably provided within the slide recess 733 along the width direction.

In the present embodiment, the fixation panel 732 is fixedly connected to the box door, and the slide recess 733 guides the movement of the slide member 740 along the width direction of the box door. Stable and reliable movement of the slide member 740 along the width of the box door may be ensured based on sliding engagement between the slide member 740 and the slide recess 733.

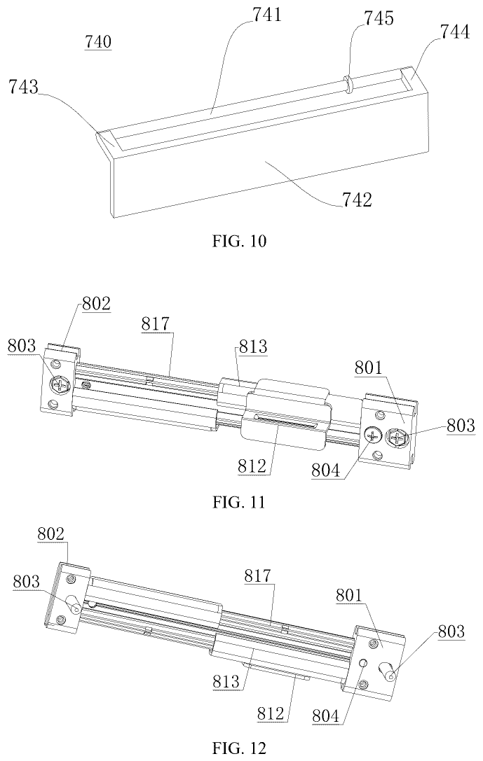

In some embodiments, as shown in FIG. 9 and FIG. 10, the guide 730 further includes a slide bushing 734 provided at the end of the slide slot 733 away from the hinge.

The slide member 740 includes a guide rod 741 and a slide block 742. The guide rod 741 penetrates through the slide bushing 734 and is provided with a slide contact 745 movably provided in the slide recess 733 along the width direction. The slide block 742 is connected to the guide rod 741 and is connect to the door panel.

The elastic member 770 is provided between the slide bushing 734 and the slide contact 745.

The slide recess 733 of the present embodiment is provided in an arc shape to adapt to the outer wall of the guide rod 741. The slide bushing 734 is configured to guide the movement of the guide rod 741 relative to the slide recess 733. As the slide member 740 moves at the slide recess 733, the slide contact 745 also moves accordingly. The slide bushing 734 is fixed relative to the fixation panel 732 and the elastic member 770 is limited between the slide bushing 734 and the slide contact 745. When the guide rod 741 moves toward the side away from the hinge, the slide member 740 moves, the slide contact 745 moves toward the slide bushing 734 to compress the elastic member 770 between the slide bushing 734 and the slide contact 745. When the guide rod 741 moves toward a side close to the hinge, the elastic member 770 releases its elastic potential energy and extends, causing the slide contact 745 to move away from the slide bushing 734. The slide bushing 734 and the slide contact 745 limit the elastic member 770 from both sides to ensure reliable compression and extension of the elastic member 770.

Furthermore, a first end of the slide block 742 is connected to the guide rod 741 and a second end of to the door panel. Sliding may drive the door panel to move along the width direction of the box door as the guide rod 741 moves along the width direction of the box door.

In some embodiments, as shown in FIG. 8, the elastic member 770 includes a spring sleeved outside the guide rod 741 and limited between the slide bushing 734 and the slide contact 745.

When the elastic member 770 is provided as a spring, its hollow structure allows the spring to sleeve the outer wall of the guide rod 741. The spring undergoes compression and extension along a length direction of the guide rod 741. Furthermore, the slide bushing 734 and slide contact 745 limit the spring from two ends of the guide rod 741 to stop two ends of the spring when the spring is compressed and extended. The spring in the present embodiment allows a simple and compact structure when the door panel is restored relative to the box door, and the mounting space of the box door is saved.

In some embodiments, as shown in FIG. 8 and FIG. 9, the slide member 740 further includes a first connection arm 743 and a second connection arm 744.

The first connection arm 743 and the second connection arm 744 are spaced apart along the width direction. A first end of the guide rod 741 is connected to a first end of the slide block 742 through the first connection arm 743, and a second end of the guide rod 741 is connected to a second end of the slide block 742 through the second connection arm 744.

The slide bushing 734 and slide contact 745 are located between the first connection arm 743 and the second connection arm 744.

The first connection arm 743 and the second connection arm 744 connect the guide rod 741 and the slide block 742 at their respective ends. This ensures a secure connection between the guide rod 741 and the slide block 742, and facilitates the slide block 742 to be aligned with the width direction of the box door as it moves along the width direction.

Furthermore, in the present embodiment, the slide block 742 is provided perpendicular to the first connection arm 743 and the second connection arm 744. When the door panel is mounted at the slide block 742, the fixation panel 732 is mounted at the top of the box door, the door panel is aligned in parallel with the box door to ensure flatness of mounting the door panel on the box door and facilitates its movement of the door panel along the box door.

In an embodiment, the slide mechanism, in addition to the aforementioned rail-slider or link forms, may also adopt a gear-rack form, a cable structure, or other similar forms. The specific structure is not limited, as long as the slide mechanism may drive the door panel to move relative to the box door. Correspondingly, the traction mechanism is also not limited to the above examples. For example, the traction mechanism may employ a cylinder, a cable, or other structures, which are not listed here. Furthermore, the traction mechanism may be either electric structure or a mechanical structure.

In an embodiment of the present application, as shown in FIG. 4, FIG. 11, and FIG. 12, the door body assembly further includes a first driven guide rail mechanism 8. The first driven guide rail mechanism 8 is provided in parallel to the slide mechanism at the box door 2 and includes a second pedestal 817 and a third slider 813. The second pedestal 817 is formed with a third guide rail, the third slider 813 is slidably provided at the third guide rail. The third slider 813 is provided with a second connection block 812 and the second connection block 812 is formed with a slot to which the door panel 21 is hanged.

In the present embodiment, the first driven guide rail mechanism 8 is provided in parallel to the slide mechanism at the box door 2. The first driven guide rail mechanism 8 includes a second pedestal 817, the second pedestal 817 is provided with the third guide rail and the third slider 813 that slides along the third guide rail. The third slider 813 is connected to the door panel 21 through a second connection block 812. The third slider 813 slides with the door panel 21 as it slides relative to the box door 2 for providing support and assisting in the sliding of the door panel 21, and ensuring smoother sliding relative to the box door 21. Furthermore, the first driven guide rail mechanism 8 matches with the slide mechanism to limit the direction of movement of the door panel 21, reducing any shaking of the door panel 21 during sliding and ensuring more stable sliding. Moreover, the slots in the second connection block 812 facilitate the user to mount the door panel 21 at the driven guide rail mechanism.

Furthermore, the first driven guide rail mechanism 8 further includes a third fixation base 801 and a fourth fixation base 802. Both the third fixation base 801 and the fourth fixation base 802 are provided with limit slots similar to those for the first second fixation base 701 and the second fixation base 702.

Specifically, the third fixation base 801 is provided with a third fixation hole, and the second pedestal 817 is provided with a third waist-type hole extending along a width direction of the second pedestal 817. A third adjustment member 804 penetrates through the third fixation hole and is slidably provided at the third waist-type hole to adjust a position of the third adjustment member 804 within the third waist-type hole.

The fourth fixation base 802 may be also provided with the third fixation hole, and the second pedestal 817 is provided with the third waist-type hole extending along a width direction of the second pedestal 817. The third adjustment member 804 penetrates through the third fixation hole and is slidably provided at the third waist-type hole to adjust a position of the third adjustment member 804 within the third waist-type hole.

Furthermore, the third fixation base 801 is provided with a fourth waist-type hole extending along the direction the width of the second pedestal 817. The first pedestal 817 is provided with a fourth fixation hole. A second adjustment member 803 sequentially penetrates through the fourth waist-type hole and a second fixation hole to be fixed to an external structure to adjust a position of the third fixation base 801 relative to the external structure by adjusting a position of the fourth adjustment member 803 in the fourth waist-type hole.

The fourth fixation base 802 may further be provided with the fourth waist-type hole extending along the width direction of the third pedestal 902. The fourth adjustment member 803 sequentially penetrates through the fourth waist-type hole and the fourth fixation hole to be fixed to the external structure to adjust a position of the fourth fixation base 802 relative to the external structure by adjusting a position of the fourth adjustment member 803 in the fourth waist-type hole.

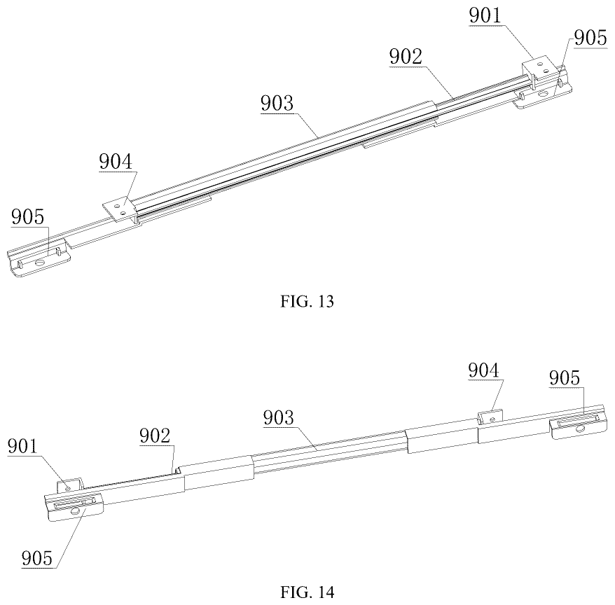

In an embodiment of the present application, as shown in FIG. 4, FIG. 13, and FIG. 14, the door body assembly further includes a second driven guide rail mechanism 9 provided offset from the slide mechanism. The second driven guide rail mechanism 9 includes the third pedestal 902 and a fourth slider 903. The third pedestal 902 is formed with a fourth guide rail and the fourth slider 903 is slidably provided at the fourth guide rail. The fourth slider 903 is provided with a plurality of third connection blocks 905, each of which has a slot to which the door panel 21 is hanged.

In the present embodiment, by providing the second driven guide rail mechanism 9, the fourth slider 903 of the second driven guide rail mechanism 9 may slide with the door panel 21 as it slides relative to the box door 2 for providing support and assisting in the sliding of the door panel 21, and ensuring more stable and smoother sliding relative to the box door 21.

At the same time, since the second driven guide rail mechanism 9 is provided offset from the slide mechanism, the third connection blocks 905 may match with the slide mechanism to limit the direction of movement of the door panel 21, preventing the door panel 21 from deflecting around the sliding direction during sliding, making the sliding process more stable and reliable.

In an embodiment of the present application, as shown in FIG. 13 and FIG. 14, two end of the third pedestal 902 of the second driven guide rail mechanism 9 are provided with a fifth fixation base 901 and a sixth fixation base 904 for being fixedly connected to the box door 2.

Furthermore, in an embodiment of the present application, as shown in FIG. 4 and FIG. 11 to FIG. 14, the slide mechanism, the first driven guide rail mechanism 8, and the second driven guide rail mechanism 9 are provided along the width direction of the box door 2. The first driven guide rail mechanism 8 is provided in parallel to the slide mechanism, while the second driven guide rail mechanism 9 is provided offset from the slide mechanism.

The width direction of the box door 2 is parallel to a plane on which the box door 2 rests and perpendicular to its axis of rotation, allowing the door panel 21 to move away from or toward a rotary shaft of the box door 2.

In the present embodiment, by providing the first driven guide rail mechanism 8 parallel to the slide mechanism, the third slider 813 may slide parallel to the slide mechanism, effectively assisting the door panel 21 in sliding relative to the box door 2 under the drive of the slide mechanism. Simultaneously, the second connection block 812 may match with the slide mechanism to limit the movement direction of the door panel 21, preventing it from swinging during movement. At the same time, since the second driven guide rail mechanism 9 is provided offset from the slide mechanism, the third connection blocks 905 may match with the slide mechanism to limit the direction of movement of the door panel 21, preventing the door panel 21 from deflecting around the sliding direction during sliding, making the sliding process more stable and reliable.

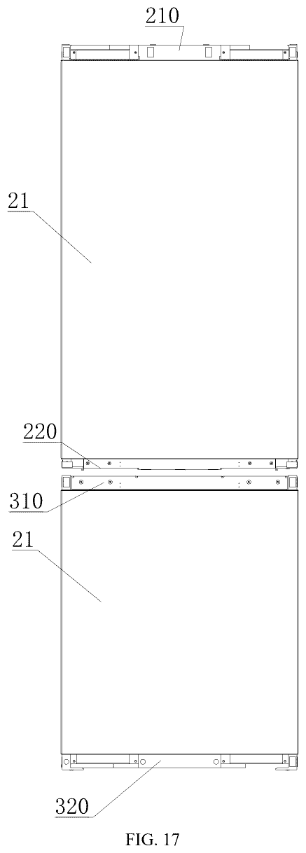

In an embodiment of the present application, as shown in FIG. 17 to FIG. 20, the door body assembly further includes: a first end cover 210 and a second end cover 220. The first end cover 210 is provided at a first end of the box door 2 and is provided with a first mount slot 213 in which the slide mechanism and the first driven guide rail mechanism 8 are provided. The second end cover 220 is provided at a second end of the box door 2 and is provided with a second mount slot in which the second driven guide rail mechanism 9 is provided.

In the present embodiment, by providing the first end cover 210 and second end cover 220, respectively at each end of the box door 2, and forming the first mount slot 213 in the first end cover 210 for mounting the slide mechanism and the first driven guide rail mechanism 8, and the second mount slot in the second end cover 220 for mounting the second driven guide rail mechanism 9, the structure of the slide mechanism, the first driven guide rail mechanism 8, the second driven guide rail mechanism 9, and the box door 2 is made more compact and aesthetically pleasing.

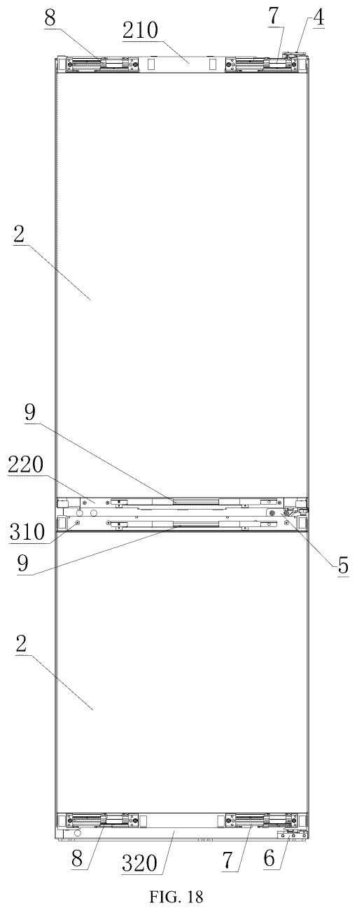

In an embodiment of the present application, as shown in FIG. 18, both the first driven guide rail mechanism 8 and the second driven guide rail mechanism 9 are provided along the width direction of the box door 2, the slide mechanism and the first driven guide rail mechanism 8 are provided at a top of the box door 2 and the second driven guide rail mechanism 9 is provided at a bottom of the box door 2.

In the present embodiment, by providing the slide mechanism and the first driven guide rail mechanism 8 at the top of the box door 2 and the second driven guide rail mechanism 9 at the bottom of the box door 2, the top of the box door 2 is connected to the door panel 21 through the slide mechanism and the first driven guide rail mechanism 8, while the bottom of the box door 2 is connected to the door panel 21 through the second driven guide rail mechanism 9. This provides a more stable and reliable connection between the door panel 21 and the box door 2.

In another embodiment of the present application, both the first driven guide rail mechanism 8 and the second driven guide rail mechanism 9 are provided along the width direction of the box door 2, the slide mechanism and the first driven guide rail mechanism 8 are provided at a bottom of the corresponding box door 2 and the second driven guide rail mechanism 9 of the first door body assembly is provided at a top of the corresponding box door 2.

In the present embodiment, by providing the slide mechanism and the first driven guide rail mechanism 8 at the bottom of the box door 2 and the second driven guide rail mechanism 9 at the top of the box door 2, the top of the box door 2 is connected to the door panel 21 through the slide mechanism and the first driven guide rail mechanism 8, while the bottom of the box door 2 is connected to the door panel 21 through the second driven guide rail mechanism 9. This provides a more stable and reliable connection between the door panel 21 and the box door 2.

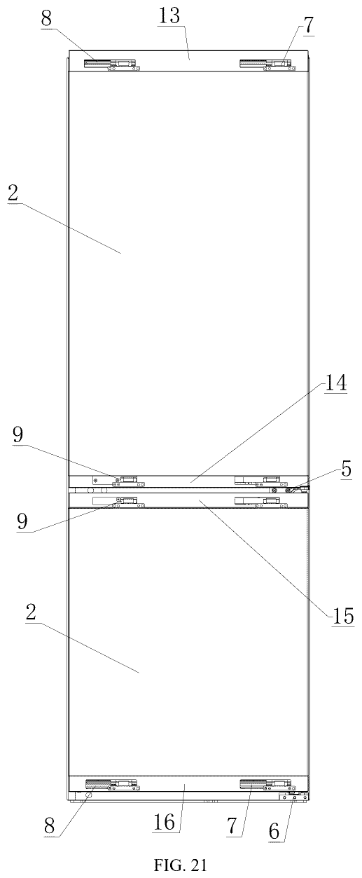

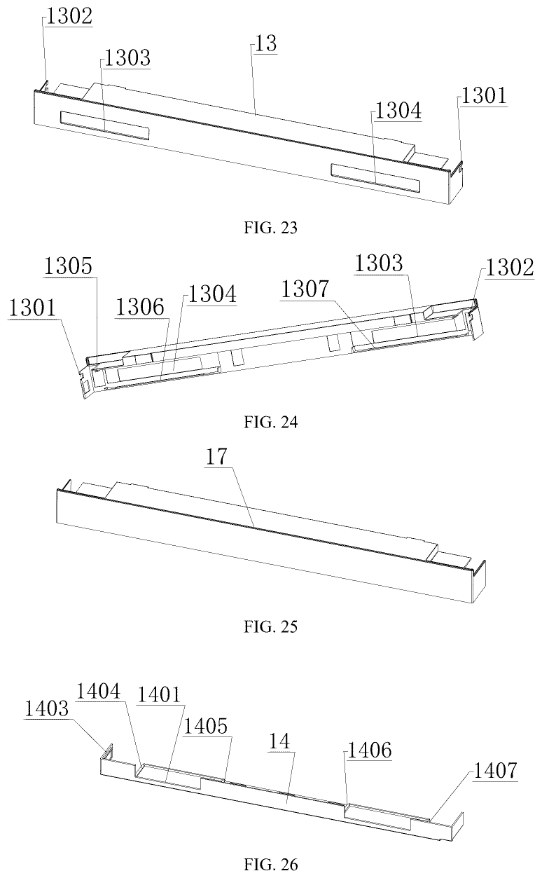

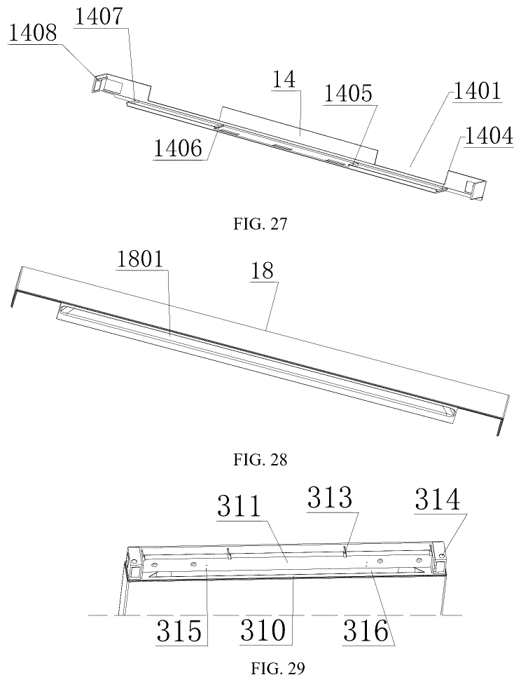

Furthermore, as shown in FIG. 21, FIG. 23, FIG. 24, FIG. 26, and FIG. 27, in an embodiment of the present application, the door body assembly further includes: a first primary decorative cover 13 and a second primary decorative cover 14. The first primary decorative cover 13 is detachably provided at the first end cover 210 and is formed with a first notch 1303 and a second notch 1304. An end of the first connection block 712 with a slot penetrates through the first notch 1303, and an end of the second connection block 812 with a slot penetrates through the second notch 1304. The second primary decorative cover 14 is detachably provided at the second end cover 220 and is formed with a third notch 1401 and an end of the first connection block 712 with a slot penetrates through the third notch 1401.

In the present embodiment, by providing the first primary decorative cover 13 at the box door 2, the first primary decorative cover 13 may cover the entire slide mechanism and the first driven guide rail mechanism 8, preventing them from being completely exposed and enhancing the appearance. Furthermore, the first primary decorative cover 13 is formed with a first notch 1303 and a second notch 1304 to allow the slide mechanism and the first driven guide rail mechanism 8 to extend through the first notch 1303 and the second notch 1304, respectively to the exterior of the first primary decorative cover 13 and connect to the door panel 21, thereby driving the door panel 21 to slide. By providing the second primary decorative cover 14 detachably at the box door 2 to cover the second driven guide rail mechanism 9, the second driven guide rail mechanism 9 is prevented from being exposed to enhance the overall aesthetics of the box door 2. The second driven guide rail mechanism 9 penetrates through the third notch 1401 and is connected to the door panel 21 for guiding the movement of the door panel 21 relative to the box door 2 during opening and closing of the box door 2.

The colors and materials of the first primary decorative cover 13 and the second primary decorative cover 14 of the present embodiment may be designed to match the material and color of the exterior surface of the box door 2 (for example, maintaining consistency or forming a decorative pattern with the exterior surface of the box door 2) to enhance the overall aesthetics of the cupboard.

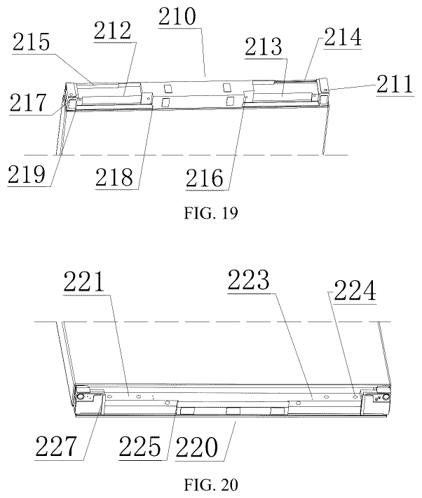

In an embodiment of the present application, as shown in FIG. 19, FIG. 23, and FIG. 24, one of the first primary decorative cover 13 and the first end cover 210 is provided with a first protrusion, and the other thereof is provided with a first recess corresponding to the first protrusion. The first primary decorative cover 13 is detachably connected to the first end cover 210 through the first protrusion and first recess.

As shown in FIG. 20, FIG. 26, and FIG. 27, one of the second primary decorative cover 14 and the second end cover 220 is provided with a second protrusion, and the other thereof is provided with a second recess corresponding to the second protrusion. The second primary decorative cover 14 is detachably connected to the second end cover 220 through the second protrusion and the second recess.

In the present embodiment, the first end cover 210 is provided with a first protrusion, and the first primary decorative cover 13 is provided with a first recess. The first protrusion and the first recess may be snapped each other to fix the first primary decorative cover 13 and the first end cover 210.

The positions of the first protrusion and the first recess are interchangeable, that is, the first end cover 210 is provided with the first recess, and the first primary decorative cover 13 is provided with the first protrusion.

Similarly, as shown in FIG. 20, FIG. 26, and FIG. 27, the second end cover 220 is provided with a second protrusion, and the second primary decorative cover 14 is provided with a second recess. The second protrusion and the second recess may be snapped each other to fix the second primary decorative cover 14 and the second end cover 220.

The positions of the second protrusion and the second recess are interchangeable, that is, the second end cover 220 is provided with the second recess, and the second primary decorative cover 14 is provided with the second protrusion.

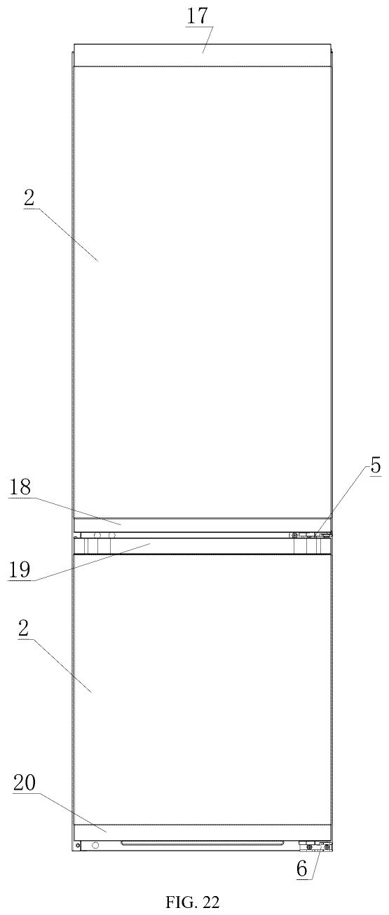

In an embodiment of the present application, as shown in FIG. 22, FIG. 25, and FIG. 28, the door body assembly further includes a first secondary decorative cover 17 and a second secondary decorative cover 18. The first secondary decorative cover 17 is detachably provided at the first end cover 210 to shield the slide mechanism and the first driven guide rail mechanism 8; the second secondary decorative cover 18 is detachably provided at the second end cover 220 to shield the second driven guide rail mechanism 9.

In the present embodiment, in some usage scenarios, no door panel 21 is required at the outside of the box door 2. Instead, the first secondary decorative cover 17 may replace the first primary decorative cover 13 on the first end cover 210, and the second secondary decorative cover 18 may replace the second primary decorative cover 14 at the second end cover 220 to shield the two driven guide rail mechanisms of the slide mechanism. This improves the visual consistency of the box door 2, enhances its aesthetics, and accommodates different user needs.

In some embodiments of the present application, one of the first secondary decorative cover 17 and the first end cover 210 is provided with a first protrusion, and the other thereof is provided with a first recess corresponding to the first protrusion. The first secondary decorative cover 17 is detachably connected to the first end cover 210 through the first protrusion and the first recess.

One of the second primary decorative cover 18 and the second end cover 220 is provided with a second protrusion, and the other thereof is provided with a second groove corresponding to the second protrusion. The second primary decorative cover 18 is detachably connected to the second end cover 220 through the second protrusion and the second recess.

In the present embodiment, the first end cover 210 is provided with a first protrusion, and the first secondary decorative cover 17 is provided with a first recess. The first protrusion and the first recess may be snapped each other to fix the first secondary decorative cover 17 and the first end cover 210.

The positions of the first protrusion and the first recess are interchangeable, that is, the first end cover 210 is provided with a first recess, and the first secondary decorative cover 17 is provided with a first protrusion.

Similarly, the second end cover 220 is provided with a second protrusion, and the second secondary decorative cover 18 is provided with a second recess. The second protrusion and the second recess may be snapped each other to fix the second secondary decorative cover 18 and the second end cover 220.

The positions of the second protrusion and the second recess are interchangeable, i.e., the second end cover 220 is provided with the first recess, and the second secondary decorative cover 18 is provided with the second protrusion.

In some embodiments, at least one of the first end cover 210, the second end cover 220, the first secondary decorative cover 17, and the second secondary decorative cover 18 is provided with a hand grip slot for the user to open or close the box door 2.

In some embodiments, by providing the hand grip slot at at least one of the first end cover 210, the second end cover 220, the first secondary decorative cover 17, and the second secondary decorative cover 18, it facilitates the user's hand access to manually open or close the box door 2, resulting in a simple structure and convenient operation.

As shown in FIG. 28, when there is no need to mount the door panel 21, the second driven guide rail mechanism 9 in the second mount slot may be removed. Accordingly, a position of the second auxiliary decorative cover 18 corresponding to the second mount slot is provided with a concave handle portion 1801, which is convenient for the user to manually open and close the box door 2.

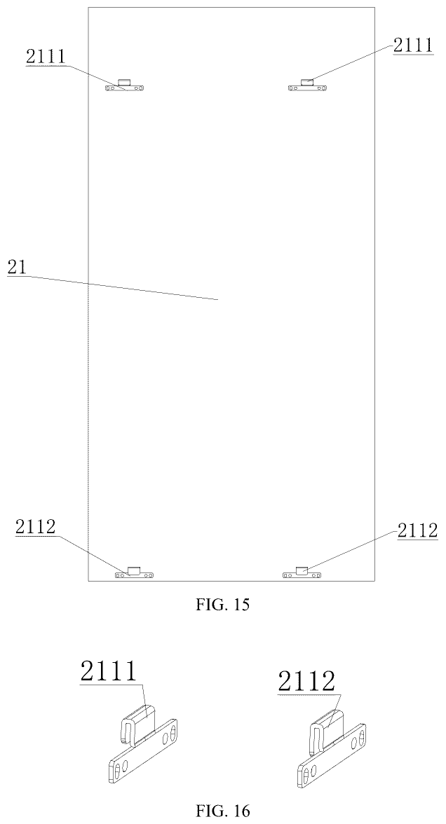

In an embodiment of the present application, as shown in FIG. 15 and FIG. 16, a top of the door panel 21 is provided with a first hook 2111, and a bottom of the door panel 21 is provided with a second hook 2112. The second hook 2112 has a length longer than that of the first hook 2111. The first hook 2111 and the second hook 2112 are inserted into corresponding slots.

In the present embodiment, by providing the first hook 2111 and the second hook 2112 at the top and bottom of the door panel 21, respectively, the door panel 21 may be connected to the slots of the slide mechanism and the two driven guide rail mechanisms through the first hook 2111 and the second hook 2112, thereby slidably connecting the door panel 21 to the box door 2. The first hook 2111 and the second hook 2112 are located at the top and bottom of the door panel 21, respectively, preventing the door panel 21 from shaking.

Furthermore, the second hook 2112 has a length longer than that of the first hook 2111. When the door panel 21 is mounted at the outside of the box door 2, the slot at the bottom of the door panel 21 is first hooked with the second hook 2112 to initially position the bottom of the door panel 21. The position and angle of the door panel 21 are then adjusted to insert the first hook 2111 at the top of the door panel 21 into the slot at the top of the box door 2. This makes it easier for the user to align the slot with the first hook 2111 and the second hook 2112, and it facilitates installation.

Specifically, the first hook 2111 includes a connection portion and a hook portion provided at the connection portion. The hook portion is hook-shaped and is designed to be hanged into the slot. The connection portion is provided with at least one horizontally extending waist-type hole and at least one vertically extending waist-type hole. The door panel 21 is provided with a fastening hole corresponding to the first hook 2111. The door panel 21 is fixedly connected to the first hook 2111 through a fastener that penetrates through the waist-type hole and the fastening hole. By adjusting the position of the fastener within the waist-type hole, the position of the first hook 2111 may be fine-tuned, facilitating mounting of the door panel 21 and fine-tuning its position and angle.

The second hook 2112 has a similar structure to the first hook 2111 and is not further described here.

In an embodiment of the present application, the door body assembly and the box body 1 are provided within a mounting space formed between a first cupboard and a second cupboard. During the opening or closing of the box door 2, a slide mechanism is configured to drive the door panel 21 to move a predetermined distance on the box door 2, to avoid the box door 2 from the sidewalls of the first cupboard body and the second cupboard body.

In the present embodiment, the box body 1 is provided between the first cupboard body and the second cupboard body. The material and color of the door panel 21 may be designed to be similar or identical to the outer walls of the cupboard. When the box door 2 is closed, the door panel 21 is flush with the outer walls of the first cupboard body and the second cupboard body on either side, maintaining visual consistency and minimizing the gap between them, enhancing the appearance.

When the box door 2 rotates outward to be opened, the slide mechanism drives the door panel 21 to slide a predetermined distance away from the first hinge 4 to prevent interference with the cupboard wall close to the first hinge 4, which could prevent the box door 2 from opening to a larger angle. When the box door 2 rotates to be closed, the slide mechanism drives the door panel 21 to slide a predetermined distance toward the first hinge 4 to prevent interference with the cupboard wall away from the first hinge 4, which could prevent the box door 2 from fully closing and affect the function of the box body 1. When the box door 2 is fully closed, the door panel 21 returns to a flush position with the cupboards. By designing a reasonable predetermined distance, the door panel 21 may avoid interference with the cupboard walls when sliding relative to the box door 2.

In another embodiment of the present application, the door body assembly and the box body 1 are provided within the cupboard. During the opening or closing of the box door 2, a slide mechanism is configured to drive the door panel 21 to move a predetermined distance on the box door 2, to avoid the box door 2 from the sidewalls of the cupboards.

In the present embodiment, the box body 1 is provided within a single cupboard. The material and color of the door panel 21 may be designed to be similar or identical to the outer walls of the cupboard. When the box door 2 is closed, the door panel 21 is flush with the outer walls of the cupboard, maintaining visual consistency and minimizing the gap between them, enhancing the appearance.

When the box door 2 rotates outward to be opened, the slide mechanism drives the door panel 21 to slide a predetermined distance away from the first hinge 4 to prevent interference with the cupboard wall close to the first hinge 4, which could prevent the box door 2 from opening to a larger angle. When the box door 2 rotates to be closed, the slide mechanism drives the door panel 21 to slide a predetermined distance toward the first hinge 4 to prevent interference with the cupboard wall away from the first hinge 4, which could prevent the box door 2 from fully closing and affect the function of the box body 1. When the box door 2 is fully closed, the door panel 21 returns to a flush position with the cupboards. By designing a reasonable predetermined distance, the door panel 21 may avoid interference with the cupboard walls when sliding relative to the box door 2.

In another embodiment of the present application, as shown in FIG. 1 and FIG. 2, a refrigeration apparatus is provided, including: a box body 1 and a door body assembly according to any of the above embodiments. The box body 1 is formed with a storage space, and the box door 2 is rotatably connected to the box body 1 for opening or closing the storage space.

In the present embodiment, the door body assembly includes: a box door 2, a door panel 21, and a slide mechanism. The slide mechanism, provided at the box door 2, is configured to drive the door panel 21 to move relative to the width direction of the box door 2 during the opening or closing process of the box door 2.

By providing a door panel 21 at the box door 2, when the refrigeration apparatus is embedded, provided within a recessed space, or provided between two cupboards, the door panel 21 may be flush with the cupboards on the side walls or sides of the recess, minimizing the gap between the refrigeration apparatus and the adjacent walls or cupboards, creating a more aesthetically pleasing design.

Simultaneously, as the box door 2 rotates, the slide mechanism may drive the door panel 21 to move relative to the box door 2 as far away from obstacles such as the wall or cupboards on the side of the box body 1 as possible during the rotation of the box door 2 to prevent these obstacles from blocking the door panel 21 and affecting the rotation of the box door 2, potentially preventing the box door 2 from opening or closing properly.

The combination of the box door 2 and the door panel 21 prevents the door panel 21 from interfering with surrounding objects during opening and closing, significantly improving user convenience. This design advantage is particularly evident in cramped kitchen environments. Furthermore, the slide mechanism ensures smooth movement of the door panel 21 during opening and closing, enhancing the lifespan and stability of the refrigerator.

If the door body assembly exhibits the beneficial effects of the above-described embodiments, the refrigeration apparatus also exhibits the beneficial effects of the above-described embodiments, which are not repeated herein.

In an embodiment, the box body 1 may have one or more storage spaces, each storage space corresponds to a corresponding door body assembly. A plurality of storage spaces may be provided in any manner, such as vertically, horizontally, or in a similar arrangement.

In some embodiments of the present application, as shown in FIG. 4, the box body 1 is formed with at least two storage spaces, and multiple door body assemblies are provided, each door body assembly corresponds to one of the storage spaces. When any box door 2 is opened or closed, the door panel 21 is driven to move relative to the corresponding box door 2.

In the present application, the box body 1 is provided with at least two storage spaces, and the two storage spaces may be configured to have different storage environments (different temperatures, humidity levels, etc.) to meet the storage requirements of different items. Each storage space is provided with a corresponding door body assembly, and the box door 2 of the corresponding door body assembly may open or close the corresponding storage space, allowing the two storage spaces to be opened or closed independently, making it convenient for the user to store or retrieve items within the storage spaces. The door panel 21 of each door body assembly may also slide relative to the corresponding box door 2. When the box door 2 is closed, the door panel 21 may be flush with the adjacent cupboard, or when the box door 2 is opened, the door panel 21 may avoid obstacles on either side.

In an embodiment of the present application, as shown in FIG. 4, the box body 1 is provided with a first storage space and a second storage space. Accordingly, the door body assembly further includes a first door body assembly and a second door body assembly. The box door 2 of the first door body assembly is rotatably connected to the box body 1 to open or close the first storage space, and the box door 2 of the second door body assembly is rotatably connected to the box body 1 to open or close the second storage space.

Furthermore, the first door body assembly and the second door body assembly are provided vertically along a height direction of the box door 2. The first door body assembly further includes a first driven guide rail mechanism 8 and a second driven guide rail mechanism 9. The second door body assembly further includes a first driven guide rail mechanism 8 and a second driven guide rail mechanism 9. The slide mechanism and the first driven guide rail mechanism 8 of the first door body assembly are provided at a top of the corresponding box door 2, while the second driven guide rail mechanism 9 of the first door body assembly is provided at a bottom of the corresponding box door 2. The slide mechanism and the first driven guide rail mechanism 8 of the second door body assembly are provided at a bottom of the corresponding box door 2, while the second driven guide rail mechanism 9 of the first door body assembly is provided at a top of the corresponding box door 2.

Specifically, as shown in FIG. 4, the box body 1 is provided with a first connection hole 110, and the first hinge 4 is connected to the first connection hole 110 of the box body 1. The box body 1 is rotatably connected to the box door 2 of the first door body assembly through the first hinge 4.

The first storage space is separated from the second storage space through a first beam body 120. The first beam body 120 is provided with a second connection hole 121, and the first beam body 120 is connected to the second hinge 5 through the second connection hole 121. The second hinge 5 has two hinge shafts distributed in an up-and-down direction, and the two hinge shafts are rotatably connected to the box door 2 of the first door body assembly and the box door 2 of the second door body assembly, respectively.

A second beam body 130 is provided at a bottom of the second storage space. The second beam body 130 is provided with a third connection hole 132 and a fourth connection hole 131. The second beam body 130 is rotatably connected to the box door 2 of the second door body assembly through the third connection hole 132 and the third hinge 6. The second beam body 130 is connected to the slide mechanism of the second door body assembly through the fourth connection hole 131.

The top and bottom of the box door 2 of the first door body assembly are provided with a first end cover 210 and a second end cover 220, respectively. The first end cover 210 is rotatably connected to the first hinge 4, while the second end cover 220 is rotatably connected to a hinge shaft located above the second hinge 5 to rotate the box door 2 of the first door body assembly relative to the box body 1.

The top and bottom of the box door 2 of the second door body assembly are provided with a third end cover 310 and a fourth end cover 320, respectively. The fourth end cover 320 is rotatably connected to the third hinge 6, while the third end cover 310 is rotatably connected to a hinge shaft located below the second hinge 5 to rotate the box door 2 of the second door body assembly relative to the box body 1.

In an embodiment of the present application, as shown in FIG. 4 and FIG. 19, two ends of the first end cover 210 are provided with first hinge holes 211 rotatably connected to the first hinge 4 and the first end cover 210 may be connected to the first hinge 4 through the first hinge hole 211 at one end. The first end cover 210 is provided with a first mount slot 213, and the wall of the first mount slot 213 is provided with a first mount hole 216. The slide mechanism is bolted to the wall of the first mount slot 213 through the first mount hole 216. A wall of the first mount slot 213 facing the box body 1 is provided with a first avoidance opening 214 corresponding to the traction mechanism. The traction mechanism is movably inserted into the first avoidance opening 214 to pull the slide mechanism with the movement of the box door 2.

The first end cover 210 is further provided with a third mount slot 212 in which the first driven guide rail mechanism 8 is mounted. The positions of the slide mechanism and the first driven guide rail mechanism 8 may be interchanged depending on the hinge position of the box door 2 and the box body 1. Accordingly, a wall of the third mount slot 212 facing the box body 1 is provided with a second avoidance opening 215 for avoiding the traction mechanism.

Specifically, opposing side walls of the first mount slot 213 and third mount slot 212 are provided with a third recess 218 and a fourth recess 219 as well as a first protrusion ridge 217 for insertion to be inserted and fixed with the first primary decorative cover 13 or the first secondary decorative cover 17.

Specifically, as shown in FIG. 23 and FIG. 24, two side surfaces of the first primary decorative cover 13 are provided with the first notch 1303 and the second notch 1304 corresponding to the first mount slot 213 and the third mount slot 212, respectively to allow the slide mechanism and the first driven guide rail mechanism 8 to extend beyond the notches and be connected to the door panel 21. Two ends of the first primary decorative cover 13 are provided with a fourth notch 1302 and a fifth notch 1301 to allow the traction mechanism to swing with the movement of the box door 2 when the slide mechanism is mounted in the first mount slot 213 or the third mount slot 212. The first primary decorative cover 1 is provided with a first snap slot 1305 corresponding to the first protrusion ridge 217, an inner side of the first notch 1303 is provided with a first protrusion rib 1307 snapped to a wall of the first mount slot 213 and an inner side of the second notch 1304 is provided with a second protrusion rib 1306 snapped to a wall of the second mount slot 212.

Correspondingly, the first secondary decorative cover 17 has a similar structure to the first primary decorative cover 13 except notches through which the slide mechanism and the first driven guide rail mechanism 8 extend. These details are not repeated here.

As shown in FIG. 20, an inner wall of the second mount slot of the second end cover 220 is provided with a third mount hole 224, and the first guide rail fixation base 221 is mounted within the second mount slot through the third mount hole 224. The first guide rail fixation base 221 is provided with a second mount hole 223 and the second driven guide rail mechanism 9 is provided at the first guide rail fixation base 221 through the second mount hole 223.

Specifically, opposing side walls of the second mount slot are provided with a second protrusion ridge 225 and a third protrusion ridge 227 for insertion to be inserted and fixed with the second primary decorative cover 14 or the first secondary decorative cover 17.

In an embodiment of the present application, as shown in FIG. 13, FIG. 14, FIG. 26, and FIG. 27, there are two third connection blocks 905, the second primary decorative cover 14 is provided with two third notches 1401 corresponding to the two third connection blocks 905 of the second driven guide rail mechanism 9, and the second primary decorative cover 14 is also formed with a chamber covered by the second end cover 220. Two ends of the chamber are provided with a fourth protrusion ridges 1403 and a fifth protrusion ridge 1408 and a bottom of the chamber is provided with a sixth protrusion ridges 1404 and a seventh protrusion ridge 1407 to be assembled with the third protrusion ridge 227 at the second end cover 220 together. Furthermore, the bottom of the chamber is further provided with a second snap slot 1405 and a third snap slot 1406 matched with and snapped to the second protrusion ridge 225 each other to assemble the second end cover 220 and the second primary decorative cover 14 together.

As shown in FIG. 4, FIG. 17, and FIG. 18, the top and bottom of the box door 2 of the second door body assembly are provided with the third end cover 310 and the fourth end cover 320, respectively. The fourth end cover 320 is rotatably connected to the third hinge 6, while the third end cover 310 is rotatably connected to a hinge shaft located below the second hinge 5 to rotate the box door 2 of the second door body assembly relative to the box body 1.

As shown in FIG. 4, FIG. 21, and FIG. 22, the second door body assembly further includes a third primary decorative cover 15, a fourth primary decorative cover 16, a third secondary decorative cover 19, and a fourth secondary decorative cover 20.

The third primary decorative cover 15 and the third secondary decorative cover 19 are detachably mounted to the third end cover 310 at the top of the second door body assembly. The third primary decorative cover 15 has a similar structure to the second primary decorative cover 14 and the third secondary decorative cover 19 has a similar structure to the second secondary decorative cover 18.

The fourth primary decorative cover 16 and the fourth secondary decorative cover 20 are detachably mounted to the fourth end cover 320 at the bottom of the second door body assembly. The fourth primary decorative cover 16 has a similar structure to the fourth primary decorative cover 13 and the fourth secondary decorative cover 20 has a similar structure to the first secondary decorative cover 17.

Specifically, when the door panel 21 of the second door body assembly is to be installed, the third primary decorative cover 15 and the fourth primary decorative cover 16 may be mounted at the third end cover 310 and the fourth end cover 320, respectively. When no door panel 21 is required, the third primary decorative cover 15 and the fourth primary decorative cover 16 may be removed, and the third secondary decorative cover 19 and the fourth primary decorative cover 16 may be mounted at the third end cover 310 and the fourth end cover 320, respectively.

As shown in FIG. 29, two ends of the third end cover 310 are provided with second hinge holes 314 rotatably connected to the second hinge 5 and a side of the third end cover 310 facing away from the box door 2 is provided with the hand grip slot 316. The third end cover 310 is provided with a fourth mount slot into which the second guide rail fixation base 311 is mounted. The second guide rail fixation base 311 is provided with a fourth mount hole 315 through which the second driven guide rail mechanism 9 of the second door body assembly is mounted at the second guide rail fixation base 311. A top surface of the third end cover 310 is provided with a plurality of eighth protrusion ridges 313 inserted with the third primary decorative cover 15 and the third secondary decorative cover 19.

Accordingly, as shown in FIG. 31 and FIG. 32, the third primary decorative cover 15 is provided with two sixth notches 1501 corresponding to the second driven guide rail mechanism 9 and the third primary decorative cover 15 is further provided with a plurality of fourth snap slots 1503 corresponding to the eighth protrusion ridges 313. When the third primary decorative cover 15 is snapped to the third end cover 310, the hand grip slot 316 of the third end cover 310 is exposed outside, making it convenient for the user to insert their hand into the hand grip slot 316 to open and close the box door 2. The second driven guide rail mechanism 9 may be connected to the door panel 21 through the sixth notches 1501.

As shown in FIG. 33, the third secondary decorative cover 19 has a similar structure to the third primary decorative cover 15, except the notch structure for the second driven guide rail mechanism 9 to penetrate through.

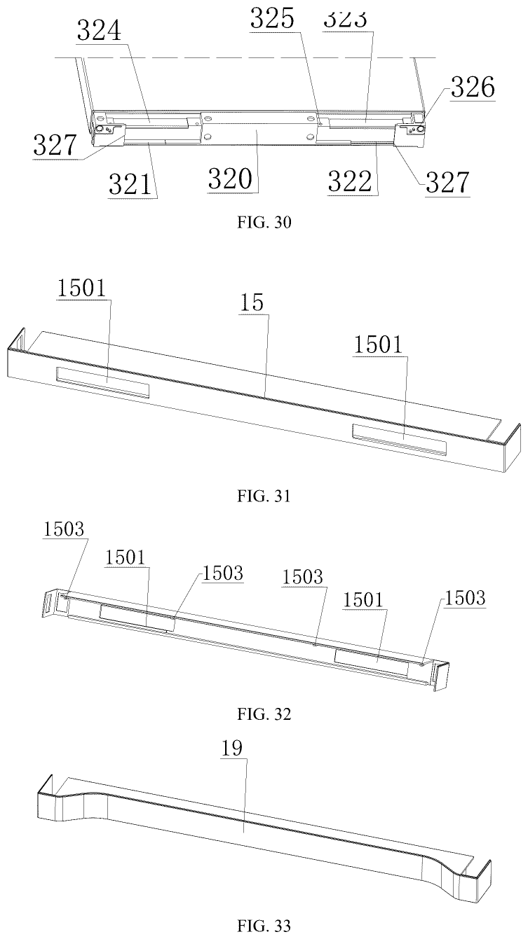

As shown in FIG. 30, the fourth end cover 320 is provided with a fifth mount slot 323 and a wall of the fifth mount slot 323 is provided with a fifth mount hole 325. The slide mechanism is bolted to the fifth mount slot 323 through the fifth mount hole 325. A wall of the fifth mount slot 323 facing the box body 1 is provided with a third avoidance opening 322 corresponding to the traction mechanism. The traction mechanism is movably inserted into the third avoidance opening 322 to pull the slide mechanism with the movement of the box door 2.

The fourth end cover 320 is further provided with a sixth mount slot 324 in which the second driven guide rail mechanism 9 is mounted. The positions of the slide mechanism and the first driven guide rail mechanism 8 may be interchanged depending on the hinge position of the box door 2 and the box body 1. Accordingly, a wall of the sixth mount slot 324 facing the box body 1 is provided with a fourth avoidance opening 321 for avoiding the traction mechanism. The fourth end cover 320 is provided with a ninth protrusion ridge 327 matched with and snapped to the fourth primary decorative cover 16 and the fourth secondary decorative cover 20.

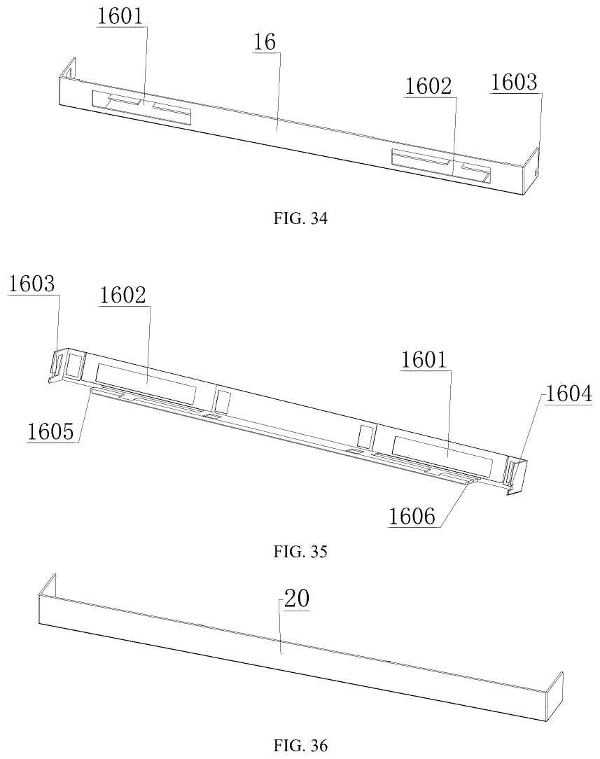

Accordingly, as shown in FIG. 34 and FIG. 35, two side surfaces of the fourth primary decorative cover 16 are provided with a seventh notch 1601 and an eight notch 1602 corresponding to the fifth mount slot 323 and the sixth mount slot 324, respectively to allow the slide mechanism and the first driven guide rail mechanism 8 to extend beyond the notches and be connected to the door panel 21. Two ends of the fourth primary decorative cover 16 are provided with a ninth notch 1604 and a tenth notch 1603 to allow the traction mechanism to swing with the movement of the box door 2 when the slide mechanism is mounted in the fifth mount slot 323 or the sixth mount slot 324. The fourth primary decorative cover 16 is provided with a fifth snap slot 1606 and a sixth snap slot 1605 corresponding to the ninth protrusion ridge 327.

As shown in FIG. 36, the fourth secondary decorative cover 20 has a similar structure to the fourth primary decorative cover 16, except the notch structure for the slide mechanism and the first driven guide rail mechanism 8 to penetrate through.

Finally, it should be noted that the above embodiments are only used to illustrate the present application, but not to limit the present application. Although the application has been described in detail with reference to the embodiments, those skilled in the art should understand that various combinations, modifications, or equivalent replacements of the solutions of the application do not depart from the spirit and scope of the solutions of the application, and should all cover the scope of the claims of this application.

1. A door body assembly for an embedded refrigeration apparatus, comprising:
a box door rotatably connected to a refrigeration box body, wherein the refrigeration box body is embedded in an accommodation space formed by a mount body, a distance between a hinge shaft center of the box door and an opening of the accommodation space is t, and a distance between the hinge shaft center and an end surface of the box door on a hinge side is l3;
a slide mechanism;
a door panel movably mounted to the box door through the slide mechanism, movable along a width direction of the box door by a movement distance, d the door panel having an interference position, wherein the interference position is an outer corner of the door panel on a hinge side; and
a traction mechanism connected to the slide mechanism, wherein during an opening and closing process of the box door, the traction mechanism drives the slide mechanism to cause the door panel to move relative to the box door;
wherein a maximum door opening angle of the door body assembly is 90° to 135°, a minimum value of the movement distance d of the door panel is between 14.15 mm and 109.108 mm, and the maximum door opening angle is positively correlated with the minimum value of the movement distance d.

2. The door body assembly of claim 1, wherein a thickness of the door panel is 12 mm to 25 mm, and a thickness of the box door is 20 mm to 60 mm.

3. The door body assembly of claim 1, wherein a safety gap between the interference position of the door panel and a panel of the mount body at the maximum door opening angle is 1 mm to 5 mm, a fit-up gap between the door panel and the box door is 1 mm to 10 mm, and a gap between the box door and the refrigeration box body is 3 mm to 15 mm.

4. The door body assembly of claim 1, wherein after the interference position moves away from the accommodation space, the movement distance d of the door panel and the maximum door opening angle Δθ of the door body assembly satisfy:
$$d = ( A + B + C + D 1 + D 2 - E ) / sin ( 180 - Δθ ) ;$$
wherein A is a safety gap between the interference position of the door panel and a panel of the mount body at the maximum door opening angle, B is a fit-up gap between the door panel and the box door, C is a gap between the box door and the refrigeration box body, D1 is a thickness of the door panel, D2 is a thickness of the box door, and E is a distance between an innermost corner of the box door and the refrigeration box body at the maximum door opening angle.

5. The door body assembly of claim 1, wherein the slide mechanism comprises:
a first pedestal having a first side formed with a first guide rail and a second side formed with a second guide rail;
a first slider slidably provided at the first guide rail, wherein the traction mechanism is rotatably connected between the box body and the first slider;
a second slider slidably provided at the second guide rail for being connected to the door panel 21; and
a flexible cable having two ends connected to the first slider and the second slider, respectively;
wherein in a case that the first slider moves at the first guide rail, the first slider drives the second slider in an opposite direction at the second guide rail through the flexible cable to drive the door panel to move relative to a width direction of the box door.

6. The door body assembly of claim 5, wherein the flexible cable comprises:
a first flexible cable passing through a first end of the first pedestal, wherein two ends of the first flexible cable are connected to a first end of the first slider and the second slider, respectively; and
a second flexible cable passing through a second end of the first pedestal, wherein two ends of the second flexible cable are connected to a second end of the first slider and the second slider, respectively.

7. The door body assembly of claim 5, wherein the traction mechanism comprises a traction rod, a first rotary shaft fixation base, and a second rotary shaft fixation base;
wherein the first rotary shaft fixation base is connected to the first slider, the second rotary shaft fixation base is connected to the box body, a first end of the traction rod is rotatably connected to the first rotary shaft fixation base, and a second end of the traction rod is rotatably connected to the second rotary shaft fixation base.

8. The door body assembly of claim 1, wherein the slide mechanism comprises:
a guide and a slide member, wherein the guide is provided at the box door and is provided with a guide structure, and the slide member is provided at the door panel and is movably provided at the guide along the width direction of the box door;
a link assembly movably provided at the guide structure and is deformable under a guidance of the guide structure, wherein a second end of the link assembly is movably connected to the slide member; and
a drive rod provided at the box body and movably connected to a first end of the link assembly to drive the link assembly to be deformed during the opening and closing process of the box door to further drive the slide member to move the door panel along the width direction through the link assembly.

9. The door body assembly of claim 8, wherein the link assembly comprises:
a first link and a second link, wherein the drive rod is rotatably connected to a first end of the first link, a second end of the first link is rotatably connected to a first end of the second link through a first hinge shaft, the first hinge shaft is provided at the guide structure and moves along a thickness direction of the door panel under the guidance of the guide structure, and a second end of the second link is rotatably connected to the slide member;
wherein the drive rod is configured to drive the first end of the first link to move along the width direction, the first link is configured to drive the first hinge shaft to move along the thickness direction to change an angle between the first link and the second link, to allow the second link to drive the slide member to move in a direction opposite to the driving direction of the drive rod.

10. A refrigeration apparatus, comprising:
a box body provided with a storage space; and
the door body assembly of claim 1, wherein the box door is rotatably connected to the box body to open or close the storage space.
